(19) United States
(12) Patent Application Publication
(10) Pub. No.: US 2023/0365846 A1
(43) Pub. Date: Nov. 16, 2023

(54) CRASH DURABLE, STRESS DURABLE AND WELDABLE EPOXY ADHESIVES

(71) Applicant: Henkel AG & Co. KGaA, Duesseldorf (DE)

(72) Inventors: Nicholas Thomas Kamar, Trenton, MI (US); Syed Z. Mahdi, Rochester Hills, MI (US); Hiroko Okuno Mattice, Rochester, MI (US); Erica Elizabeth Gibbons, Clay Township, MI (US); Matthew Jay Quast, Sterling Heights, MI (US)

(21) Appl. No.: 18/359,949

(22) Filed: Jul. 27, 2023

Related U.S. Application Data
(63) Continuation of application No. PCT/US2022/018845, filed on Mar. 4, 2022.
(60) Provisional application No. 63/157,263, filed on Mar. 5, 2021.

(51) Int. Cl. C09J 163/00; C09J 11/08; C09J 11/06; C09J 11/04; C09J 5/00

(52) U.S. Cl. CPC C09J 163/00; C09J 11/08; C09J 11/06; C09J 11/04; C09J 5/00; C09J 2463/00; C09J 2475/00; C09J 2415/00; C09J 2400/166

(57) ABSTRACT

Liquid epoxy-based adhesive compositions are provided, which upon curing result in crash durable and stress resistant cured bonds on both steel and other materials, in particular metals such as aluminum; and in some embodiments are weldable in an uncured state; also provided are bonded assemblies comprising the cured epoxy-based adhesives, methods of making the liquid epoxy-based adhesives, methods of bonding assemblies and articles of manufacture comprising the bonded assemblies.

### TECHNICAL FIELD

This invention relates to liquid epoxy-based adhesives that are weldable in an uncured state and provide crash durable and stress resistant cured bonds and bonded assemblies derived from curing the liquid epoxy-based adhesives in contact with one or more substrates, and methods of making these liquid epoxy-based adhesives, methods of bonding substrates and articles of manufacture comprising the bonded assemblies.

### BACKGROUND

Epoxy-based adhesives are used in manufacturing to bond metals to other metals or to other materials, sometimes in concert with spot welding technologies. Automotive original equipment manufacturers (OEMs) require crash durable structural adhesive compositions having cured adhesion and bond durability suitable for use in vehicle assembly. Further, automotive OEMs wish to expand their processing capability by improving humidity resistance of uncured adhesive applied to a surface, such that the later cured adhesive does not lose adhesion and bond durability performance. The cured structural adhesive should exhibit high strength and toughness after exposure to hot/wet conditions in the uncured state to allow for shipment of uncured assemblies. Thus, a need exists for a single package adhesive composition that exhibits environmental stress durability on aluminum, crash durability at −40° C., particularly after low bake curing conditions, as well as improved uncured humidity resistance exhibited by high T-peel strength and impact wedge peel strength in the cured state after exposure to hot-wet conditions in the uncured state. There is a constant need for new and improved adhesives that meet these requirements. The present disclosure addresses at least some of these needs.

### SUMMARY

Applicants have discovered that unexpectedly improved liquid adhesive formulations can be prepared by mixing epoxy resins, rubber particles (preferably having a core-shell structure and/or an average particle size of less than 500 nm), end capped polyurethane toughening agents, at least one latent curing agent capable of being activated by heating and at least one accelerator different from the curing agent, and at least one additive selected from the group consisting of, carboxyl-terminated butadiene acrylonitrile-epoxy adduct, at least one plasticizer (e.g., sulfonate plasticizers, phosphate ester plasticizers), flexibilizers. Optionally, such compositions also contain flame retardants, chelate modified epoxy resin, auxiliary impact modifiers/toughening agents, fillers, thixotropic agents (such as fumed silica, mixed mineral phyllosilicates) optionally surface modified, or other adjuvants. When applied to a substrate or carrier and cured by heating, the adhesive results in a product capable of forming bonds with improved high T-peel strength and impact wedge peel strength in the cured state even after exposure to hot-wet conditions in the uncured state. A particular benefit of some embodiments is a single formulation exhibiting good adhesion to steel and aluminum substrates; this ability to adhere to both types of metal increases manufacturing flexibility in the body shop such that only a single adhesive is required at a pumping station.

The disclosure is directed to new compositions of matter, including those comprising liquid epoxy-based adhesives that upon cure provide crash durable and stress resistant cured bonds useful in adhering substrates, e.g. metal substrates, together, also provided are bonded assemblies derived by applying the uncured adhesive to one or both of the substrates to be bonded, bringing the substrates into contact such that the adhesive is located between the substrates to be bonded and curing the adhesive, and methods of making these liquid epoxy-based adhesives, methods of bonding substrates and articles of manufacture comprising the bonded assemblies. The epoxy-based adhesive compositions retain cured bond strength even when the uncured liquid epoxy-based composition is subjected to humidity exposure before curing. In some embodiments the compositions are weldable in an uncured state. Various embodiments of the invention are described throughout this disclosure, including:

Embodiment 1. A liquid epoxy adhesive composition comprising: (a) at least one epoxy resin;
(b) one or more carboxyl-terminated butadiene acrylonitriles (CTBN);
(c) rubber particles, preferably core-shell rubber particles and/or particles having a particle size of less than 500 nm;
(d) one or more blocked polyurethane toughening agents;
(e) at least one heat-activated latent curing agent preferably comprising DICY;
(f) at least one accelerator different from the curing agent;
wherein the one or more blocked polyurethane toughening agents comprises at least one asymmetrically end-capped polyurethane.

The epoxy adhesive can further contain other additives such as flame retardants, polyetheramine flexibilizers, fillers, coupling agents, plasticizers, diluents, extenders, pigments and dyes, thixotropic agents, expanding agents, flow control agents, adhesion promoters and antioxidants. In certain Aspects of this Embodiment, the liquid epoxy adhesive composition is free of formaldehyde.

Embodiment 2. The liquid epoxy adhesive composition of Embodiment 1 further characterized in that said components are or comprise:
(a) one or more diglycidyl ether of a bisphenol-A (DGEBA) epoxy resins or bisphenol-F (DGEBF) epoxy resins, desirably present in a range of from 20 wt. % to 60 wt. %;
(b) one or more carboxyl-terminated butadiene homopolymers or butadiene acrylonitrile copolymers (CTBN), desirably present in a range of from 1 wt. % to 8 wt. %;
(c) core shell rubber (CSR) particles, desirably present in a range of from 5 wt. % to 30 wt. %;
(d) one or more blocked polyurethane toughening agents, desirably present in a range of from 5 wt. % to 20 wt. %;
(e) one or more dicyandiamides (DICY), desirably present in a range of from 2 wt. % to 6 wt. %;
(f) one or more urea-based accelerator, desirably present in a range of from 0.5 wt. % to 2.0 wt. %;
(g) one or more filler, desirably present in a range of from 0 wt. % to 20 wt. %;
(h) one or more phenol novolac epoxies, desirably present in a range of from 0 wt. % to 20 wt. %;
(i) one or more flame retardants, desirably present in a range of from 0 wt. % to 35 wt. %;
(j) one or more polyetheramine flexibilizer, desirably present in a range of from 0 wt. % to 12 wt. %; and
(k) one or more plasticizers, desirably present in a range of from 0 wt. % to 5 wt. %;
wherein the wt. % of each component is relative to the total weight of the composition and the total amount of the components does not exceed 100 wt. %.

Embodiment 3. The liquid epoxy adhesive composition of Embodiment 1 or 2, wherein (a) the one or more diglycidyl ether of the bisphenol-A (DGEBA) epoxy resin or bisphenol-F (DGEBF) epoxy resin is present in a range of from 20 wt. % to 25 wt. %, from 25 wt. % to 30 wt. %, from 30 wt. % to 35 wt. %, from 35 wt. % to 40 wt. %, from 40 wt. % to 45 wt. %, from 45 wt. % to 50 wt. %, from 50 wt. % to 55 wt. %, from 55 wt. % to 60 wt. %, or any combination of two or more of the foregoing ranges, for example from 25 wt. % to 55 wt. %, or any of the foregoing values, relative to the total weight of the composition.

Embodiment 4. The liquid epoxy adhesive composition of any one of Embodiments 1 to 3, wherein (b) one or more carboxyl-terminated butadiene acrylonitrile (CTBN) is present in a range of from 1 wt. % to 1.1 wt. %, from 1.1 wt. % to 1.2 wt. %, from 1.2 wt. % to 1.3 wt. %, from 1.3 wt. % to 1.4 wt. %, from 1.4 wt. % to 1.5 wt. %, from 1.5 wt. % to 1.6 wt. %, from 1.6 wt. % to 1.7 wt. %, from 1.7 wt. % to 1.8 wt. %, from 1.8 wt. % to 1.9 wt. %, from 1.9 wt. % to 2 wt. %, from 2 wt. % to 2.5 wt. %, from 2.5 wt. % to 3 wt. %, from 3 wt. % to 3.5 wt. %, from 3.5 wt. % to 4 wt. %, from 4 wt. % to 4.5 wt. %, from 4.5 wt. % to 5 wt. %, from 5 wt. % to 5.5 wt. %, from 5.5 wt. % to 6 wt. %, from 6 wt. % to 6.5 wt. %, from 6.5 wt. % to 7 wt. %, from 7 wt. % to 7.5 wt. %, from 7.5 wt. % to 8 wt. %, or any combination of two or more of the foregoing ranges, for example from 1.3 wt. % to 1.6 wt. %, or any of the foregoing values, relative to the total weight of the composition;

Embodiment 5. The liquid epoxy adhesive composition of any one of Embodiments 1 to 4, wherein (c) the core shell rubber (CSR) particles are present in a range of from 5 wt. % to 6 wt. % from 6 wt. % to 7 wt. %, from 7 wt. % to 8 wt. %, from 8 wt. % to 9 wt. %, from 9 wt. % to 10 wt. %, from 10 wt. % to 11 wt. %, from 11 wt. % to 12 wt. %, from 12 wt. % to 13 wt. %, 13 wt. % to 14 wt. %, from 14 wt. % to 15 wt. %, from 15 wt. % to 16 wt. %, from 16 wt. % to 17 wt. %, from 17 wt. % to 18 wt. %, from 18 wt. % to 19 wt. %, from 19 wt. % to 20 wt. %, from 20 wt. % to 21 wt. %, from 21 wt. % to 22 wt. %, from 22 wt. % to 23 wt. %, from 23 wt. % to 24 wt. %, from 24 wt. % to 25 wt. %, from 25 wt. % to 26 wt. %, from 26 wt. % to 27 wt. %, from 27 wt. % to 28 wt. %, from 28 wt. % to 29 wt. %, from 29 wt. % to 30 wt. %, or any combination of two or more of the foregoing ranges, for example from 10 wt. % to 15 wt. %, or any of the foregoing values, relative to the total weight of the composition;

Embodiment 6. The liquid epoxy adhesive composition of any one of Embodiments 1 to 5, wherein (d) the one or more blocked polyurethane toughening agent is present in a range of from 5 wt. % to 6 wt. % from 6 wt. % to 7 wt. %, from 7 wt. % to 8 wt. %, from 8 wt. % to 9 wt. %, from 9 wt. % to 10 wt. %, from 10 wt. % to 11 wt. %, from 11 wt. % to 12 wt. %, from 12 wt. % to 13 wt. %, 13 wt. % to 14 wt. %, from 14 wt. % to 15 wt. %, from 15 wt. % to 16 wt. %, from 16 wt. % to 17 wt. %, from 17 wt. % to 18 wt. %, from 18 wt. % to 19 wt. %, from 19 wt. % to 20 wt. %%, or any combination of two or more of the foregoing ranges, for example from 5 wt. % to 7 wt. %, or any of the foregoing values, relative to the total weight of the composition;

Embodiment 7. The liquid epoxy adhesive composition of any one of Embodiments 1 to 6, wherein (e) the at least one heat-activated latent curing agent comprising DICY, wherein the one or more dicyandiamide (DICY) is present in a range of from 2 wt. % to 2.5 wt. %, from 2.5 wt. % to 3 wt. %, from 3 wt. % to 3.5 wt. %, from 3.5 wt. % to 4 wt. %, from 4 wt. % to 4.5 wt. %, from 4.5 wt. % to 5 wt. %, from 5 wt. % to 5.5 wt. %, or any combination of two or more of the foregoing ranges, for example from 3 wt. % to 4 wt. %, or any of the foregoing values, relative to the total weight of the composition;

Embodiment 8. The liquid epoxy adhesive composition of any one of Embodiments 1 to 7, wherein (f) the at least one accelerator different from the curing agent; such as one or more urea-based accelerators, e.g. a substituted urea accelerator is present in a range of from 0.5 wt. % to 0.6 wt. % to 0.7 wt. %, from 0.7 wt. % to 0.8 wt. %, from 0.8 wt. % to 0.9 wt. %, from 0.9 wt. % to 1.0 wt. %, from 1.0 wt. % to 1.1 wt. %, from 1.1 wt. % to 1.2 wt. %, from 1.2 wt. % to 1.3 wt. %, 1.3 wt. % to 1.4 wt. %, from 1.4 wt. % to 1.5 wt. %, from 1.5 wt. % to 1.6 wt. %, from 1.6 wt. % to 1.7 wt. %, from 1.7 wt. % to 1.8 wt. %, from 1.8 wt. % to 1.9 wt. %, from 1.9 wt. % to 2.0 wt. %, from 2.0 wt. % to 2.1 wt. %, from 2.1 wt. % to 2.2 wt. %, from 2.2 wt. % to 2.4 wt. %, from 2.4 wt. % to 2.5 wt. %, or any combination of two or more of the foregoing ranges, for example from 0.5 wt. % to 1 wt. %, or any of the foregoing values, relative to the total weight of the composition;

Embodiment 9. The liquid epoxy adhesive composition of any one of Embodiments 1 to 8, wherein (g) one or more filler are present in a range of from 1 wt. % to 2 wt. % from 2 wt. % to 3 wt. %, from 3 wt. % to 4 wt. %, from 4 wt. % to 5 wt. %, from 5 wt. % to 6 wt. %, from 6 wt. % to 7 wt. %, from 7 wt. % to 8 wt. %, from 8 wt. % to 9 wt. %, from 9 wt. % to 10 wt. %, from 10 wt. % to 11 wt. %, from 11 wt. % to 12 wt. %, from 12 wt. % to 13 wt. %, 13 wt. % to 14 wt. %, from 14 wt. % to 15 wt. %, from 15 wt. % to 16 wt. %, from 16 wt. % to 17 wt. %, from 17 wt. % to 18 wt. %, from 18 wt. % to 19 wt. %, from 19 wt. % to 20 wt. %, or any combination of two or more of the foregoing ranges, for example from 5 wt. % to 17 wt. %, or any of the foregoing values, relative to the total weight of the composition. The filler may be one or more organic or one or more inorganic or a combination of one or more organic and one or more inorganic fillers;

Embodiment 10. The liquid epoxy adhesive composition of any one of Embodiments 1 to 9, wherein (h) the one or more phenol novolac epoxy is present in a range of from 1 wt. % to 1.5 wt. %, from 1.5 wt. % to 2 wt. %, from 2 wt. % to 2.5 wt. %, from 2.5 wt. % to 3 wt. %, from 3 wt. % to 3.5 wt. %, from 3.5 wt. % to 4 wt. %, from 4 wt. % to 4.5 wt. %, from 4.5 wt. % to 5 wt. %, from 5 wt. % to 5.5 wt. %, from 5.5 wt. % to 6 wt. %, from 6 wt. % to 6.5 wt. %, from 6.5 wt. % to 7 wt. %, from 7 wt. % to 7.5 wt. %, from 7.5 wt. % to 8 wt. %, from 8 wt. % to 8.5 wt. %, from 8.5 wt. % to 9 wt. %, from 9 wt. % to 9.5 wt. %, from 9.5 wt. % to 10 wt. %, 10 wt. % to 12 wt. %, from 12 wt. % to 14 wt. %, from 14 wt. % to 16 wt. %, from 16 wt. % to 20 wt. %, or any combination of two or more of the foregoing ranges, for example from 4.5 wt. % to 6.5 wt. % or from 4.5 wt. % to 9 wt. %, or any of the foregoing values, relative to the total weight of the composition.

Embodiment 11. The liquid epoxy adhesive composition of any one of Embodiments 1 to 10, wherein (i) the one or more flame retardant is present in a range of from 0 wt. % to 1 wt. %, 1 wt. % to 2 wt. %, from 2 wt. % to 3 wt. %, from 3 wt. % to 4 wt. %, from 4 wt. % to 5 wt. %, from 5 wt. % to 6 wt. %, from 6 wt. % to 7 wt. %, from 7 wt. % to 8 wt. %, from 8 wt. % to 9 wt. %, from 9 wt. % to 10 wt. %, from 10 wt. % to 11 wt. %, from 11 wt. % to 12 wt. %, from 12 wt. % to 13 wt. %, 13 wt. % to 14 wt. %, from 14 wt. % to 15 wt. %, from 15 wt. % to 16 wt. %, from 16 wt. % to 17 wt. %, from 17 wt. % to 18 wt. %, from 18 wt. % to 19 wt. %, from 19 wt. % to 20 wt. %, from 20 wt. % to 22 wt. %, from 22 wt. % to 24 wt. %, from 24 wt. % to 26 wt. %, from 26 wt. % to 28 wt. %, from 28 wt. % to 30 wt. %, from 30 wt. % to 35 wt. %, or any combination of two or more of the foregoing ranges, for example from 2 wt. % to 16 wt. %, or any of the foregoing values, relative to the total weight of the composition;

Embodiment 12. The liquid epoxy adhesive composition of any one of Embodiments 1 to 11, wherein (j) one or more polyetheramine flexibilizer is present in a range of from 0 wt. % to 1 wt. %, from 1 wt. % to 1.5 wt. %, from 1.5 wt. % to 2 wt. %, from 2 wt. % to 2.5 wt. %, from 2.5 wt. % to 3 wt. %, from 3 wt. % to 3.5 wt. %, from 3.5 wt. % to 4 wt. %, from 4 wt. % to 4.5 wt. %, from 4.5 wt. % to 5 wt. %, from 5 wt. % to 5.5 wt. %, from 5.5 wt. % to 6 wt. %, from 6 wt. % to 6.5 wt. %, from 6.5 wt. % to 7 wt. %, from 7 wt. % to 7.5 wt. %, from 7.5 wt. % to 8 wt. %, from 8 wt. % to 8.5 wt. %, from 8.5 wt. % to 9 wt. %, from 9 wt. % to 9.5 wt. %, from 9.5 wt. % to 10 wt. %, from 10 wt. % to 10.5 wt. %, from 10.5 wt. % to 11 wt. %, from 11 wt. % to 11.5 wt. %, from 11.5 wt. % to 12 wt. %, or any combination of two or more of the foregoing ranges, for example from 1.5 wt. % to 10 wt. %, or any of the foregoing values, relative to the total weight of the composition.

Embodiment 13. The liquid epoxy adhesive composition of any one of Embodiments 1 to 12, wherein (k) one or more plasticizer is present in a range of from 0 wt. % to 1 wt. %, from 1 wt. % to 1.5 wt. %, from 1.5 wt. % to 2 wt. %, from 2 wt. % to 2.5 wt. %, from 2.5 wt. % to 3 wt. %, from 3 wt. % to 3.5 wt. %, from 3.5 wt. % to 4 wt. %, from 4 wt. % to 4.5 wt. %, from 4.5 wt. % to 5 wt. %, or any combination of two or more of the foregoing ranges, for example from 0 wt. % to 2 wt. %, or any of the foregoing values, relative to the total weight of the composition.

Embodiment 14. The liquid epoxy adhesive composition of any one of Embodiments 1 to 13, wherein the one or more diglycidyl ether of the bisphenol-A (DGEBA) epoxy resin or bisphenol-F (DGEBF) epoxy resin comprises one or more of a diglycidyl ether of a bisphenol-A (DGEBA) epoxy resin. In other Aspects of this Embodiment, the one or more diglycidyl ether comprises one or more of a diglycidyl ether of a bisphenol-F (DGEBF) epoxy resin. In some Aspects of this Embodiment, the diglycidyl ether includes at least one liquid (at 23° C.) diglycidyl ether of bisphenol A, of bisphenol F, or of both bisphenol A and bisphenol F. Such an epoxy resin may further include at least one solid (at 23° C.) diglycidyl ether of bisphenol A and/or of bisphenol F. Such an epoxy resin mixture may contain up to 5% monohydrolyzed species that are present as impurities in one or more of the constituent resins.

Embodiment 15. The liquid epoxy adhesive composition of any one of Embodiments 1 to 14, wherein the one or more of diglycidyl ether of the bisphenol-A (DGEBA) epoxy resin has an Epoxy Equivalent Weight (EEW) in a range of from 180 to 195, preferably from 185 to 192, where

$$EEW = \frac{MW epoxy resin}{\# of epoxy groups} .$$

Embodiment 16. The liquid epoxy adhesive composition of any one of Embodiments 1 to 15, wherein the one or more phenol novolac epoxy has an EEW in a range of from 165 to 185, preferably from 172 to 179.

Embodiment 17. The liquid epoxy adhesive composition of any one of Embodiments 1 to 16, wherein the one or more carboxyl-terminated butadiene acrylonitrile (CTBN) comprises a copolymer of butadiene and a nitrile monomer, preferably comprising or consisting of acrylonitrile. While the specific nature of the butadiene acrylonitrile is set forth elsewhere and incorporated herein as independent Aspects of this Embodiment, in preferred Aspects, CTBN compositions has a range of about 22-30 wt. % more preferably 26% acrylonitrile.

Embodiment 18. The liquid epoxy adhesive composition of any one of Embodiments 1 to 17, wherein the one or more carboxyl-terminated butadiene acrylonitrile (CTBN) is adducted with DGEBF.

Embodiment 19. The liquid epoxy adhesive composition of any one of Embodiments 1 to 18, wherein the core shell rubber (CSR) particles:
(a) are practically monomodally or bimodally dispersed;
(b) have a mean particle size of 50 nm, 75 nm, 100 nm, 125 nm, 150 nm, 175 nm, 200 nm, 250 nm, or 500 nm, or in a range bounded by any two of the foregoing values;
(c) have a core comprising, consisting essentially of, or consisting of polybutadiene, a butadiene/styrene copolymer, or an acrylic polymer or copolymer; and/or
(d) are dispersed in DGEBA epoxy resin.

Each of the various descriptions concerning these CSR particles (characterizations, compositions, and sizes) set forth elsewhere in this disclosure as seen as independent Aspects of this Embodiment.

Embodiment 20. The liquid epoxy adhesive composition of any one of Embodiments 1 to 19, wherein the one or more blocked polyurethane toughening agent comprises a polyalkylene glycol segment. In preferred Aspects of this Embodiment, this polyalkylene glycol segment independently comprises a polyethylene glycol, a polypropylene glycol, or a polybutylene glycol (alternatively a polytetramethylene glycol (poly-THF or PTMEG), having an equivalent molecular weight in a range of from 2000-5000 Daltons. PTMEG linkages are preferred. In other further preferred Aspects of this Embodiment, polyurethane toughening agent also contains polyalkylene (extender) segments, preferably where the polyalkylene glycol segment is flanked by end-capped C₁₋₁₀ alkylene linkages, preferably C₆₋₈ alkylene linkages and coupled thereto by urethane groups.

In further preferred Aspects of this Embodiment, the one or more blocked polyurethane toughening agent is end-capped at both ends of the structure and at least one of the flanking C₁₋₁₀ alkylene linkages is end-capped. The two end-caps of the toughener may be the same or different. Selecting combinations of differing end-caps allows one to tune the deblocking temperatures. In some Aspects of this Embodiment, then, the end caps are selected such that de-blocking temperatures for the toughener are in a range of from 135° C. to 140° C., from 140° C. to 145° C., from 145° C. to 150° C., from 150° C. to 160° C., from 160° C. to 165° C., or a range defined by any two or more of the foregoing ranges, for example from 140° C. to 150° C.

In some Aspects of this Embodiment, at least one end-cap is a bisphenol (e.g., bis-phenol A) group. Huntsman's DY 965 is one commercially available sample of such toughening agents, in which the end-caps comprise bisphenol.

While in some cases, end-capping may be the same at both ends of the molecule, e.g., by one or more bisphenol (e.g., bis-phenol A) groups may be acceptable, it is observed that blocking groups that provide lower deblocking temperatures are also acceptable and, in some cases, preferred. In some Aspects of this Embodiment, such end-capping agents include optionally substituted phenols (or hydroxyheteroaryl analogs), amines, methacryl, acetoxy, oximes, and/or pyrazoles.

In some Aspects of this Embodiment, end-capping may be asymmetrical, meaning ends of the polyurethane molecule may be blocked with different functional groups, e.g., the optionally substituted phenols, amines, methacryl, acetoxy, oximes, and/or pyrazoles. One example of substitution on the phenols may include C₁₂₋₂₄ pendant functional groups comprising 1, 2, 3, or 4 conjugated and/or non-conjugated alkenylene bonds.

For example, in independent Aspects of this Embodiment, at least one of the flanking C₁₋₁₀ alkylene linkages is end-capped by a monophenol comprising at least one C₁₂₋₂₄ pendant functional group, the at least one C₁₂₋₂₄ pendant functional group containing 1, 2, 3, or 4 conjugated and/or non-conjugated alkenylene bonds. Again, the use of substituted monophenols is preferred in that they appear to provide a lower curing temperature than the bisphenol end-caps.

Other independent Aspects of this Embodiment include those tougheners wherein at least one end-cap is derived from methylethylketoxime, 2,4-dimethyl-3-pentanone oxime or 2,6-dimethyl-4-heptanone oxime, diethyl malonate, 3,5-dimethylpyrazole, 1,2,4-triazole, or mixtures of diisopropylamine and 1,2,4-triazole, or combinations thereof.

Embodiment 21. The liquid epoxy adhesive composition of any one of Embodiments 1 to 20, wherein the at least one heat-activated latent curing agent comprising DICY; comprises one or more dicyandiamide (DICY) that is a micronized dicyandiamide (cyanoguanidine). In certain Aspects of this Embodiment, the micronized dicyandiamide is not fully dissolved in the liquid epoxy adhesive composition. In certain Aspects of this Embodiment, at least 98% of the micronized dicyandiamide has a particles size of 40 microns or less. In other Aspect, at least 98% of the micronized dicyandiamide has a particles size of 10 microns or less. In other Aspect, at least 98% of the micronized dicyandiamide has a particles size of 6 microns or less.

Embodiment 22. The liquid epoxy adhesive composition of any one of Embodiments 1 to 21, wherein the one or more flame retardant is present. In certain Aspects of this Embodiment, the flame retardant is or comprises one or more of aluminum trihydrate (ATH), an ammonium polyphosphate, melamine, melamine polyphosphate, a phosphonate ester (e.g., diethyl bis(hydroxyethyl) aminomethyl phosphonate, a halogen-free phosphorus ester, or any combination of an unsubstituted, mono-, di-, or tri-butylated phenyl phosphates. In certain Aspects of this Embodiment, the flame retardant is a liquid, and the composition is free of solid flame retardants, optionally ATH may be present as a filler.

Embodiment 23. The liquid epoxy adhesive composition of any one of Embodiments 1 to 22, wherein the one or more filler comprises one or more of calcium carbonate, calcium oxide, calcium silicate, aluminosilicate, organophilic phyllosilicates, naturally occurring clays such as bentonite, wollastonite or kaolin glass, silica, mica, talc, microspheres (polymeric or glass beads), or hollow glass microspheres, chopped or milled fibers [e.g., carbon, glass, or aramid], pigments, zeolites (natural or synthetic), or thermoplastic fillers.

Embodiment 24. The liquid epoxy adhesive composition of any one of Embodiments 1 to 23, wherein the at least one accelerator different from the curing agent may be one or more accelerators comprising urea, a guanidine that is not cyanoguanidine, or a substituted urea accelerator; preferably a substituted urea accelerator, more preferably a micronized substituted urea accelerator. In certain Aspects of this Embodiment, the substituted urea accelerator is substituted urea and/or a bridged diurea (with each urea substituted with one, two, three, or four alkyl and/or aromatic groups. In some aspects of this embodiment, the one or more accelerators preferably comprises substituted urea, optionally alkyl substituted urea comprising dimethyl urea, e.g., 1,1 dimethyl urea and/or 1,3 dimethyl urea, such as set forth elsewhere herein and incorporated here. In some Aspects of this Embodiment, the accelerator becomes activated in a temperature range of 100° C. to 120° C., from 120° C. to 140° C., from 140° C. to 160° C., or from 160° C. to 180° C., or a combination of two or more of these ranges. In certain Aspect of this Embodiment, the substituted urea accelerator becomes activated at a temperature that exceeds the deblocking temperature of the polyurethane, preferably at a temperature of at least about 160° C. to meet low temperature cure in E-coat ovens. In some Aspects of this Embodiment, liquid epoxy adhesive composition comprises at least two accelerators.

Embodiment 25. The liquid epoxy adhesive composition of any one of Embodiments 1 to 24, wherein the one or more polyetheramine flexibilizer is a polyalkylene glycol, comprising amine end-caps, the one or more polyetheramine flexibilizer being present as a DGEBA adduct. The polyetheramine is preferably an end-capped polypropylene glycol characterized by repeating oxypropylene units in the backbone. The polypropylene glycol has an average weight averaged molecular weight in a range of from about 1000 to 3000 Daltons, preferably 1500 to 2500 or more preferably about 2000 Daltons. Such materials are commercially available as JEFFAMINE® D-2000 polyetheramine.

Embodiment 26. The liquid epoxy adhesive composition of any one of Embodiments 1 to 25, wherein the one or more plasticizer is present and is or comprises tricresyl phosphate. In certain Aspects of this Embodiment, the plasticizer is selected from the group consisting of triphenylphosphate, tricresyl phosphate, and phenyl cresyl esters of pentadecyl sulfonic acid.

Embodiment 27. A method of making a composite article which comprises: contacting a surface with the liquid epoxy adhesive composition of any one of Embodiments 1 to 26, provisionally adhering an uncured epoxy on the surface. In certain Aspects of this Embodiment, at least two surfaces are contacted with the composition, said surfaces being positioned such that the uncured epoxy is positioned therebetween.

Embodiment 28. A cured epoxy adhesive layer that has been prepared by thermally curing a liquid epoxy adhesive composition of any one of Embodiments 1 to 27 on a substrate. In certain Aspects of this Embodiment, the cured epoxy adhesive layer has a nominal thickness in a range of from 0.25 to 0.5 mm nominal, preferably about 0.25 mm.

Embodiment 29. The cured epoxy adhesive layer of Embodiment 28 that has been cured: (a) at a temperature of 160° C. for 10 minutes; or (b) at a temperature of 205° C. for 30 minutes. Time refers to the total time the adhesive is at the indicated cure temperature. The epoxy adhesive layer may be cured at other temperatures as dictated by the paint cure over parameters, e.g., in the range of 150-210, 160-205, 165-200 and other temperatures within the recited ranges. Cure times of 10-30 minutes include other cure times within the recited ranges. Other temperature time combinations may be used as is known in the art. The adhesive may be cured at higher temperatures and longer cure times provided that the cure conditions do not interfere with other objects of the invention with respect to performance of the cured adhesive.

Embodiment 30. The cured epoxy adhesive layer of Embodiment 28 or 29, wherein the substrate is a cold rolled steel (CRS), an electro galvanized steel (EZG), a hot dip galvanized steel (HDG), or a treated aluminum. In certain Aspects of this Embodiment, the substrate (also called an adherend) has a thickness in a range of from 0.7 mm to 2.0 mm.

Embodiment 31. The cured epoxy adhesive layer of any one of Embodiments 28 to 30 that exhibits a 100% cohesive mode of failure in peel on cold rolled steel (CRS), electro galvanized steel (EZG), hot dip galvanized steel (HDG), and/or treated aluminum when tested under T-peel conditions of ASTM D1876-08(2015)e1 or under the wedge impact method of ISO 11343.2019.

Embodiment 32. The cured epoxy adhesive layer of any one of Embodiments 28 to 31, which:
(a) having been cured between two 0.8 mm thick cold rolled steel plates at 160° C. for 10 min provides adhesion between the plates sufficient to exhibit a T-peel strength of at least 10, 11, 12, 13, 14, or 15 N/mm at room temperature; and/or
(b) having been cured between two 0.8 mm thick cold rolled steel plates at 205° C. for 30 min on provides adhesion between the plates sufficient to exhibit a T-peel strength of at least 10, 11, 12, 13, 14, or 15 N/mm at room temperature; and/or
(c) having been cured between two 0.8 mm thick cold rolled steel plates at 160° C. for 10 min exhibits a cleavage resistance under impact loading [impact wedge peel strength] of at least 20, 22, 24, 26, 28, 30, or 32 N/mm when tested using the wedge impact method of ISO 11343.2019 at −40° C.; and/or
(d) having been cured between two 0.8 mm thick cold rolled steel plates at 205° C. for 30 min exhibits a cleavage resistance under impact loading of at least 20, 22, 24, 26, 28, 30, or 32 N/mm when tested using the wedge impact method of ISO 11343.2019 at −40° C.; and/or
(e) having been cured between two 2.0 mm thick 5754 aluminum plates at 160° C. for 10 min provides adhesion between the plates sufficient to exhibit a T-peel strength of at least 10, 11, 12, 13, 14, or 15 N/mm; and/or
(f) having been cured between two 2.0 mm thick 5754 aluminum plates at 205° C. for 30 min provides adhesion between the plates sufficient to exhibit a T-peel strength of at least 10, 11, 12, 13, 14, or 15 N/mm; and/or
(g) having been cured between two 2.0 mm thick cold rolled steel plates at 160° C. for 30 min exhibits a cleavage resistance under impact loading of at least 24, 26, 28, 30, 32, 34, 36, or 38 N/mm when tested using the wedge impact method of ISO 11343.2019 at −40° C. Specific Aspects of this Embodiment are provided in the Examples and are incorporated herein.

Embodiment 33. The cured epoxy adhesive layer of any one of Embodiments 28 to 32 that is sufficiently durable to withstand a standardized stress durability test. In some Aspects of this Embodiment, the stress durability tests comprise subjecting the cured epoxy adhesive layer to at least 22 cycles conducted according to FLTM BV 101-07 (described elsewhere herein) or equivalent. In other Aspects of this Embodiment, the cured epoxy adhesive layer, having been cured for 10 minutes at 160° C., is able to withstand at least 25, 30, 35, 40, or 45 cycles of the environmental aging according to FLTM BV 101-07, which is incorporated by reference herein for its teaching of the standards and methods of this test.

Embodiment 34. The uncured epoxy adhesive layer of Embodiment 27, the uncured epoxy adhesive layer comprising the flame retardant that is sufficient flame-resistant to pass the conditions of: (a) FLTM BV 114-01 for steel substrates; and/or (b) FLTM BV 062-01 for aluminum substrates; and/or

Embodiment 35. An article of manufacturing comprising a liquid epoxy adhesive composition of any one of Embodiments 1 to 26, as applied thereto, or any cured epoxy adhesive layer of any one of Embodiment 28 to 33. In certain Aspects of this Embodiment, the article of manufacturing is an automobile, a home appliance, or a part thereof.

Embodiment 36. A method of preparing the liquid epoxy adhesive composition of any one of Embodiments 1 to 26, the method comprising steps, at a temperature less than the activation energy of the final desired composition, of: 1) combining liquid components, 2) mixing solid components, except curing agent and accelerator, into the combination of step 1), and 3) incorporating curing agent and accelerator into the mixture.

Embodiment 37. A method of making a bonded assembly comprising: applying the composition of any one of Embodiments 1 to 26 on a first surface, contacting at least one second surface with the composition on the first surface and curing the composition in contact with the first and second surfaces to prepare a bonded assembly. In certain Aspects of this Embodiment, one or more of the first and second surfaces is contaminated with at least one oily substance and the composition additionally comprises at least one chelate-modified epoxy resin. In other Aspects of this Embodiment, the bonded assembly is prepared by thermally curing the liquid epoxy adhesive composition at a temperature in a range of from 140 degrees C. to 220 degrees C., which when cured exhibits a 100% cohesive mode of failure of the bonded assembly in peel on cold rolled steel (CRS), electro galvanized steel (EZG), hot dip galvanized steel (HDG), and/or treated aluminum when tested under T-peel conditions of ASTM D1876-08(2015)e1 or under the wedge impact method of ISO 11343.2019.

Embodiment 38. An article of manufacturing comprising the liquid epoxy adhesive composition of any one of Embodiments 1 to 26, as applied on at least one surface of the article and uncured; or cured on the at least on surface of the article, wherein the article of manufacturing is preferably automobile or a part thereof.

The disclosure also embraces the use of these liquid epoxy adhesive compositions in forming a bonding surface comprising a corresponding cured epoxy adhesive layer and methods of using them for this purpose, as well as the cured epoxy adhesive layer that has been prepared by thermally curing the liquid epoxy adhesive compositions between substrates.

Recommended thicknesses of the cured adhesive layers are provided as are the conditions for curing the adhesive compositions. Exemplary curing conditions include curing at a temperature of 160° C. for 10 minutes; or at a temperature of 205° C. for 30 minutes. Typical substrates include, but are not limited to, cold rolled steel (CRS), an electro galvanized steel (EZG), a hot dip galvanized steel (HDG), or a treated aluminum.

Upon curing, the adhesives provide excellent adhesion between such surfaces. In some embodiments, the cured adhesive layer exhibits a 100% cohesive mode of failure in peel on cold rolled steel (CRS), electro galvanized steel (EZG), hot dip galvanized steel (HDG), and/or treated aluminum when tested under T-peel conditions of ASTM-1876. Conditions where T-peel strength of at least 10, 11, 12, 13, 14, or 15 N/mm. Conditions where a cleavage resistance under impact loading of at least 20, 22, 24, 26, 28, 30, or 32 N/mm when tested using the wedge impact method of ISO 11343.2019 at −40° C. are disclosed.

The disclosure also embraces article of manufacturing comprising any one or more of the cured epoxy adhesive layer set forth herein.

Several of the many advantages of the compositions presently disclosed include: (1) Excellent adhesion properties and impact wedge peel strength on steel and aluminum substrates, especially at −40° C. (where traditional toughened epoxy polymers tend to exhibit brittle failure under high strain rate impact events) while maintaining excellent uncured, open bead humidity resistance; (2) The use of polyurethane toughening agents provides improved adhesion to steel and aluminum and humidity resistance relative to currently commercial materials; (3) Enhanced long term durability on treated aluminum under harsh hot/wet environmental aging conditions; (4) Improved adhesion, impact wedge peel strength and mode of failure on treated aluminum; and/or (5) Enhanced uncured weld flammability resistance, while facilitating passing aluminum weld testing and exhibiting good impact wedge peel strength at −40° C. and above after ‘low bake° cure conditions utilized in automotive E-coat processes.

### BRIEF DESCRIPTION OF THE DRAWINGS

FIGS. 1A and 1B show differential scanning calorimetry (DSC) results for Comparative Example 1 and Example 2. FIG. 1A shows heat flow as a function of temperature. FIG. 1B shows a thermogram corresponding to the ‘low bake° cure condition.

FIG. 2 shows isothermal thermogravimetric analysis (TGA) curves of phosphorus flame retardants Phos. 1, Phos. 2 and Phos. 3.

### DETAILED DESCRIPTION OF ILLUSTRATIVE EMBODIMENTS

The present disclosure may be understood more readily by reference to the following description taken in connection with the accompanying Summary, Figures and Examples, all of which form a part of this disclosure. Those ingredients identified by their commercial tradenames are independent embodiments of the materials to which they are referred. Similarly, unless specifically otherwise stated, any description as to a possible mechanism or mode of action or reason for improvement is meant to be illustrative only, and the disclosure herein is not to be constrained by the correctness or incorrectness of any such suggested mechanism or mode of action or reason for improvement. Throughout this text, it is recognized that the descriptions refer to compositions and methods of making and using said compositions. That is, where the disclosure describes or claims a feature or embodiment associated with a composition or a method of making or using a composition, it is appreciated that such a description or claim is intended to extend these features or embodiment to embodiments in each of these contexts (i.e., compositions, methods of making, and methods of using).

### The Liquid Epoxy Adhesive Compositions

Certain embodiments set forth in this disclosure include liquid epoxy adhesive compositions comprising:
(a) at least one epoxy resin;
(b) one or more carboxyl-terminated butadiene acrylonitriles (CTBN);
(c) rubber particles, preferably core-shell rubber (CSR) particles, most preferably nanoscale core-shell rubber particles, meaning at least one dimension of a particle is less than 100 nm. The distribution of particle sizes may vary, with particular embodiments described herein;
(d) one or more blocked polyurethane toughening agents;
(e) at least one heat-activated latent curing agent comprising DICY;
(f) at least one accelerator different from the curing agent;
wherein the one or more blocked polyurethane toughening agents comprises at least one asymmetrically end-capped polyurethane.

In certain embodiments, the liquid epoxy adhesive compositions comprise:
(a) one or more diglycidyl ether of a bisphenol-A (DGEBA) epoxy resins or bisphenol-F (DGEBF) epoxy resins, desirably present in a range of from 20 wt. % to 60 wt. %;
(b) one or more carboxyl-terminated butadiene homopolymers or butadiene acrylonitrile copolymers (CTBN), desirably present in a range of from 1 wt. % to 8 wt. %;
(c) core shell rubber (CSR) particles, desirably present in a range of from 5 wt. % to 30 wt. %;
(d) one or more blocked polyurethane toughening agents, desirably present in a range of from 5 wt. % to 20 wt. %;
(e) one or more dicyandiamides (DICY), desirably present in a range of from 2 wt. % to 6 wt. %;
(f) one or more urea-based accelerator, desirably present in a range of from 0.5 wt. % to 2.0 wt. %;
(g) one or more filler, desirably present in a range of from 0 wt. % to 20 wt. %;
(h) one or more phenol novolac epoxies, desirably present in a range of from 0 wt. % to 20 wt. %;
(i) one or more flame retardants, desirably present in a range of from 0 wt. % to 35 wt. %;
(j) one or more polyetheramine flexibilizer, desirably present in a range of from 0 wt. % to 12 wt. %; and
(k) one or more plasticizers, desirably present in a range of from 0 wt. % to 5 wt. %;
wherein the wt. % of each component is relative to the total weight of the composition and the total amount of the components does not exceed 100 wt. %.

Each of these ranges are considered independently and exemplary independent ranges and subranges for each of these components are set forth elsewhere herein.

### Epoxy Resins

In general, a large number of polyepoxides having at least about two 12-epoxy groups per molecule are suitable as epoxy resins for the compositions of this invention. The poly epoxides may be saturated, unsaturated, cyclic or acyclic, aliphatic, alicyclic, aromatic or heterocyclic polyepoxide compounds. Examples of Suitable polyepoxides include the polyglycidyl ethers, which are prepared by reaction of epichlorohydrin or epibromohydrin with a polyphenol in the presence of alkali. Suitable polyphenols therefor are, for example, resorcinol, pyrocatechol, hydroquinone, bisphenol A (bis(4-hydroxyphenyl)-2,2-propane), bisphenol F (bis(4-hydroxyphenyl)methane), bis(4-hydroxyphenyl)-1,1-isobutane, 4,4′-dihydroxybenzophenone, and bis(4-hydroxyphenyl)-1, 1-ethane. Other suitable polyphenols as the basis for the polyglycidyl ethers are the known condensation products of phenol and formaldehyde or acetaldehyde of the novolac resin-type. Particular preference is given to the liquid epoxy resins derived by reaction of bisphenol A or bisphenol F and epichlorohydrin. The epoxy resins that are liquid at room temperature generally have epoxy equivalent weights of from 150 to about 480. In preferred embodiments of the liquid epoxy adhesive compositions, one or more of diglycidyl ether of the bisphenol-A (DGEBA) epoxy resins or bisphenol-F (DGEBF) epoxy resins may be present individually or together. In certain embodiments, one or both of these resins has an Epoxy Equivalent Weight (EEW) in a range of from 155 to 400, 160 to 300, 165 to 200, 170 to 250, or 180 to 200, preferably from 185 to 195, where

$$EEW = \frac{MW epoxy resin}{\# of epoxy groups} .$$

Suitable commercially available polyphenol polyglycidyl ether products include diglycidyl ethers of bisphenol A resins such as are sold by Olin Corporation under the tradename D.E.R.®, including the 300 and 600 series resins. Other aliphatic epoxy diluents/flexibilizers, from the D.E.R.® 700 series, may also be incorporated to decrease viscosity (i.e., as a diluent), to increase flexibility/elongation and improve adhesion.

### Carboxyl-Terminated Butadiene Acrylonitriles (CTBN)

Additionally or alternatively, in the adhesive composition, the one or more carboxyl-terminated butadiene acrylonitriles (CTBN) comprises a copolymer of butadiene and a nitrile monomer, preferably acrylonitrile or may comprise a homopolymer of butadiene. Higher acrylonitrile content is preferred in a range of 22-30 wt. % based on weight of the CTBN, and in some preferred embodiments, the CTBN compositions contain about 26 wt. % acrylonitrile. It appears that the increased solubility retards onset (kinetics) of phase separation during cure, resulting in a smaller particle size and increased fracture toughness.

These carboxyl-terminated butadiene acrylonitriles (CTBN) may contain from about 1.5, more preferably from about 1.8, to about 2.5, more preferably to about 2.2, terminal epoxide-reactive carboxyl groups per molecule, on average. The molecular weight (MO of the butadiene acrylonitrile copolymer is suitably from about 2000 to about 6000, more preferably from about 3000 to about 5000. Suitable carboxyl-functional butadiene and butadiene/acrylonitrile copolymers are commercially available from Huntsman under the tradenames Hycar® and Hypro®. In certain preferred embodiments, a portion of the one or more carboxyl-terminated butadiene acrylonitrile (CTBN) may be adducted with DGEBA or DGEBF, see suitable commercially available adducts from Huntsman under tradename Hypox™. The adduct may be dissolved or dispersed in novolac epoxy resin which aids solubility. In a preferred embodiment the CTBN is a CTBN-DGEBF adduct in novolac epoxy resin.

### Core Shell Rubber (CSR) Particles

Core shell rubber (CSR) particles generally have a core comprised of a polymeric material having elastomeric or rubbery properties (i.e., a glass transition temperature less than about 0° C., e.g., less than about −30° C.) surrounded by a shell comprised of a non-elastomeric polymeric material (i.e., a thermoplastic or thermoset/crosslinked polymer having a glass transition temperature greater than ambient temperatures, e.g., greater than about 50° C.), as measured by differential scanning calorimetry (DSC). The rubber core may constitute from 50 to 90%, especially from 50 to 85% of the weight of the core-shell rubber particle.

In some embodiments, the CSR particles have an average particle size less than about 500 nm. In still other embodiments, the CSR particles have an average particle size greater than about 500 nm, for example average particle size may be from about 0.03 to about 2 microns or from about 0.05 to about 1 micron. Desirably, the rubber particles have an average diameter of less than about 500 nm. In other embodiments, the average particle size is less than about 200 nm. For example, the rubber particles may have an average diameter within the range of from about 25 to about 200 nm or from about 50 to about 150 nm. The core-shell rubber particles may have a number average particle size (diameter) of 10 to 300 nanometers, especially 75 to 250 nanometers, as determined by transmission electron spectroscopy.

The core may be comprised of a diene homopolymer or copolymer of monomers comprising one or more of butadiene, isoprene, ethylenically unsaturated monomers such as vinyl aromatic monomers, (meth)acrylonitrile, (meth)acrylates, or the like, polybutadiene cored particles are preferred. Other suitable rubbery core polymers may include polybutylacrylate or polysiloxane elastomer (e.g., polydimethylsiloxane).

The shell may be comprised of a polymer or copolymer of one or more monomers such as (meth)acrylates (e.g., methyl methacrylate), vinyl aromatic monomers (e.g., styrene), vinyl cyanides (e.g., acrylonitrile), unsaturated acids and anhydrides (e.g., acrylic acid), (meth)acrylamides, and the like having a suitably high glass transition temperature; acrylates, in particular, poly(methylmethacrylates) are preferred. The shell polymer or copolymer may be crosslinked and/or have one or more different types of functional groups (e.g., carboxylic acid or epoxy groups) that are capable of interacting with other components of the adhesive. In one embodiment, the shell polymer may be polymerized from at least one lower alkyl methacrylate such as methyl-, ethyl- or t-butyl methacrylate. Up to 40% by weight of the shell polymer can be formed from other monovinylidene monomers such as styrene, vinyl acetate, and vinyl chloride, methyl acrylate, ethyl acrylate, butyl acrylate, and the like. The shell polymer may be a homopolymer of any of such lower alkyl methacrylate monomers. The molecular weight (Mn) of the grafted shell polymer is generally between 20,000 and 500,000. The rubber particle may be comprised of more than two layers (e.g., a central core rubbery material may be surrounded by a different rubbery material then shell or two shells or hard shell, soft shell, hard shell). The shell may be grafted onto the core.

CSR particles may be prepared as a masterbatch where the rubber particles are dispersed in one or more epoxy resins such as a diglycidyl ether of bisphenol A, preferably remaining as separated individual particles with little or no agglomeration of the particles or precipitation (settling) of the particles as the masterbatch is aged by standing at room temperature. The core-shell rubber particles may be provided as a dispersion in an epoxy or a phenolic resin matrix. Such a dispersion may contain, for example, about 5 to about 50% by weight (about 15 to about 40% by weight) of the core-shell rubbers, with the remainder being the epoxy resin. The epoxy resin in such a dispersion is preferably a polyglycidyl polyphenol ether as described above. The matrix material preferably is liquid at room temperature. Examples of epoxy matrices include the diglycidyl ethers of bisphenol A, F or S, or bisphenol, novolac epoxies, and cycloaliphatic epoxies. Examples of phenolic resins include bisphenol-A based phenoxies. Commercially available as dispersions of rubber particles having a core-shell structure in an epoxy resin matrix are those available from Kaneka Corporation under the tradename “ACE MX” described as having a polybutadiene core or a copolymer core of (meth)acrylate-butadiene-styrene, where butadiene is the primary component in phase separated particles, dispersed in epoxy resins. When the core-shell rubber particles are provided in the form of such a dispersion, only the weight of the core-shell rubber particles is counted toward the core-shell rubber component of this disclosure. Methods of making masterbatches are described EP 1632533, U.S. Pat. Nos. 4,778,851 and 6,111,015, each incorporated herein by reference in its entirety.

Examples of CSR particles suitable for use in the present compositions include those commercially available from: Rohm & Haas under the tradename PARALOID EXL 2600/3600 series, described as styrene/methylmethacrylate copolymer grafted onto a polybutadiene core, average particle size of 0.1-0.3 microns; Roehm GmbH or Roehm America, Inc. under the tradename DEGALAN; Nippon Zeon under the tradename F351; and in powder form from Wacker Chemie under the tradename GENIOPERL, described by the supplier as having crosslinked polysiloxane cores, epoxy-functionalized polymethylmethacrylate shells, polysiloxane content of about 65 weight percent.

Combinations of different core-shell rubber particles may advantageously be used in the present invention. The core-shell rubber particles may differ, for example, in particle size, the glass transition temperatures of their respective cores and/or shells, the compositions of the polymers used in their respective cores and/or shells, the functionalization of their respective shells, and so forth. A portion of the core-shell particles may be supplied to the adhesive composition in the form of a masterbatch wherein the particles are stably dispersed in an epoxy resin matrix and another portion may be supplied to the adhesive composition in the form of a dry powder (i.e., without any epoxy resin or other matrix material). For example, the adhesive composition may be prepared using both a first type of core-shell particles in dry powder form having an average particle diameter of from about 0.1 to about 0.5 microns and a second type of core-shell particles stably dispersed in a matrix of liquid bisphenol A diglycidyl ether at a concentration of from about 5 to about 50 weight % having an average particle diameter of from about 25 to about 200 nm. The weight ratio of first type: second type core-shell rubber particles may be from about 1.5:1 to about 0.3:1, for example.

Alternatively or with the CSR, the compositions may comprise rubber particles that do not have shells that encapsulate a central core. In such embodiments, the chemical composition of the rubber particles may be essentially uniform throughout each particle or may have its outer surface modified by irradiation or chemical processing to aid in dispersion in the matrix or adhesion thereto. The polymers suitable for use in preparing rubber particles that do not have shells may be selected from any of the types of polymers previously described as suitable for use as the core of core-shell rubber particles. The polymer may contain functional groups such as carboxylate groups, hydroxyl groups or the like and may have a linear, branched, crosslinked, random copolymer or block copolymer structure. Exemplary commercially available rubber particles include acrylonitrile/butadiene copolymer, butadiene/styrene/2-vinylpyridine copolymer; hydroxy-terminated polydimethylsiloxane; and similar elastomeric solid rubbers. These particles may optionally be surface modified to create polar groups (carboxylic acid or hydroxyl groups) and/or doped with minor amounts of inorganic materials such as calcium carbonate or silica, as is known in the art. When the rubber particles do not have a core-shell structure, desirably the rubber particles have an average diameter of less than about 750 nm, 500 nm, or 200 nm. For example, the rubber particles may have an average diameter ranging from about 25 to about 200 nm or from about 50 to about 150 nm.

In the adhesive composition, in some preferred embodiments, the core shell rubber (CSR) particles may be characterized by one or more of the following features: (a) the CSR particles are monomodally or bimodally dispersed, allowing for maximum concentrations; the dispersity of the CSR particles may be defined by any suitable means including sedimentation or visual or automated of transmission electron microscopy (TEM) images; (b) the CSR particles have a mean particle size of 50 nm, 75 nm, 100 nm, 125 nm, 150 nm, 175 nm, 200 nm, 250 nm, or 500 nm, or in a range bounded by any two of the foregoing values; in still another embodiment, the rubber particles have a core-shell structure and an average particle size greater than about 500 nm; (c) the CSR particles have a core comprising, consisting essentially of, or consisting of polybutadiene, a butadiene/styrene copolymer, or an acrylic polymer or copolymer; and/or (d) the CSR particles are dispersed in DGEBA epoxy resin.

In the disclosed compositions, use of these core shell rubbers allows for toughening to occur in the formulation, irrespective of the temperature or temperatures used to cure the formulation. That is, because of the two-phase separation inherent in the formulation due to the core shell rubber—as contrasted for instance with a liquid rubber that is miscible or partially miscible or even immiscible in the formulation and can solidify at temperatures different than those used to cure the formulation—there is a minimum disruption of the matrix properties, as the phase separation in the formulation is often observed to be substantially uniform in nature. In addition, predictable toughening—in terms of temperature neutrality toward cure—may be achieved because of the substantial uniform dispersion.

### Blocked Polyurethane Toughening Agents

Additionally or alternatively, in the adhesive composition, the one or more blocked polyurethane toughening agent comprises a polyalkylene glycol segment. The blocked polyurethane toughening agent provides improved adhesion to the contemplated substrates under static and dynamic peel conditions.

In preferred embodiments, this polyalkylene glycol segment independently comprises a polyethylene glycol, a polypropylene glycol, or a polybutylene glycol (alternatively a polytetramethylene glycol (poly-THF or PTMEG), having an equivalent molecular weight in a range of from 2000-5000 Daltons. PTMEG linkages are preferred. In other further preferred embodiments, the polyurethane toughening agent also contains polyalkylene (extender) segments, preferably where the polyalkylene glycol segment is flanked by end-capped C₁₋₁₀ alkylene linkages, preferably C₆₋₈ alkylene linkages and coupled thereto by urethane groups.

Other elastomeric “tougheners” having capped isocyanate groups that may also be suitable in the presently disclosed composition, have been described, for example, in any of U.S. Pat. Nos. 5,202,390, 5,278,257. WO 2005/118734, WO 2007/003650, WO2012/091842, U. S. Published Patent Application No. 2005/0070634, U. S. Published Patent Application No. 2005/0209401, U. S. Published Patent Application 2006/0276601, EP-A-0 308 664, EP 1 498 441A, EP-A 1 728 825, EP-A 1 896 517, EP-A 1 916 269, EP-A 1 916 270, EP-A 1 916 272 and EP-A-1 916 285. These elastomeric tougheners (2) can be generally described as the products of the reaction of an amine- or hydroxyl-terminated rubber with a polyisocyanate to form an isocyanate-terminated prepolymer, optionally chain-extending the prepolymer, followed by capping the isocyanate groups with a capping group such as, for example: a) aliphatic, aromatic, cycloaliphatic, araliphatic and/or heteroaromatic monoamines that have one primary or secondary amino group; b) phenolic compounds, including monophenols, polyphenols and aminophenols: c) benzyl alcohol, which may be substituted with one or more alkyl groups on the aromatic ring; d) hydroxy-functional acrylate or methacrylate compounds: e) thiol compounds such as alkylthiols having 6 to 16, carbon atoms in the alkyl group, including dodecanethiol; f) alkyl amide compounds having at least one amine hydrogen such as acetamide and N-alkylacetamide; and g) a ketoxime.

In the present compositions, the one or more blocked polyurethane toughening agent is preferably end-capped at both ends of the structure. The two end-capping groups of the blocked polyurethane toughening agent may be the same or different. Selecting combinations of differing end-caps allows one to tune the deblocking temperatures. In some embodiments, then, the end caps are chosen to provide de-blocking temperatures in a range of from 135° C. to 140° C., from 140° C. to 145° C., from 145° C. to 150° C., from 150° C. to 160° C., from 160° C. to 165° C., or a range defined by any two or more of the foregoing ranges, for example from 140° C. to 150° C.

Huntsman's DY 965 is one commercially available example of such a blocked polyurethane toughening agent, in which both end-caps comprise bisphenol. While in some cases, end-capping by one or more bisphenol (e.g., bis-phenol A) groups may be acceptable, the present inventors have found that the use of one or more blocking groups that provide lower deblocking temperatures are preferred. Such end-capping agents include optionally substituted phenols (or hydroxyheteroaryl analogs), amines, methacryl, acetoxy, oximes, and/or pyrazoles (see Johannes Karl Fink, in High Performance Polymers (Second Edition), 2014;

https://www.sciencedirect.com/topics/engineering/blocked-isocyanate). It is known, for example, that the aliphatic poly(isocyanate)s, which are blocked with equimolar quantities of diisopropylamine and malonic acid diethyl ester, have a crosslinking temperature of 130° C. Triazole blocked isocyanates are typically stable up to 130-140° C.

In some embodiments, then, the blocked polyurethane toughening agent has at least one end cap derived from methylethylketone oxime, 2,4-dimethyl-3-pentanone oxime or 2,6-dimethyl-4-heptanone oxime, diethyl malonate, 3,5-dimethylpyrazole, 1,2,4-triazole, or mixtures of diisopropylamine and 1,2,4-triazole, or combinations thereof.

End-cap substituents that are hydrophobic also appear to ensure additional benefits, including for example C₁₂₋₂₄ pendant functional groups comprising 1, 2, 3, or 4 conjugated and/or non-conjugated alkenylene bonds. Accordingly, in separate embodiments, the optional substituents of the phenols (or hydroxyheteroaryl analogs), amines, methacryl, acetoxy, oximes, and/or pyrazoles comprise such pendant functional groups.

In other embodiments, the flanking C₁₋₁₀ alkylene linkages is end-capped by at least one monophenol comprising at least one C₁₂₋₂₄ pendant functional groups, the at least one C₁₂₋₂₄ pendant functional groups containing 1, 2, 3, or 4 conjugated and/or non-conjugated alkenylene bonds. Again, the use of substituted monophenols, relative to bis-phenol is preferred in that they appear to provide a lower curing temperature than the bisphenol end-caps.

### Heat-Activated Latent Curing Agent

Compositions of the present invention are preferably one-part or single-component compositions cured at elevated temperature, containing one or more curing agents capable of accomplishing cross linking or curing of certain of the adhesive components when the adhesive is heated to an activation temperature of the curing agent and/or blocked reactants. To ensure good storage stability of the single-component, liquid epoxy adhesives, desirably, the latent curing agent has low solubility in the epoxy resins at room temperature. Solid, finely ground curing agents are preferred to permit ready dissolution at about the activation temperature, dicyandiamide (DICY) being especially suitable. In certain embodiments, the one or more dicyandiamides (DICY) of the liquid epoxy adhesive compositions is/are a micronized dicyandiamide (cyanoguanidine). The use of micronized dicyandiamide is preferred to ensure reactivity with epoxy during and after melting of the DICY, since DICY is insoluble in epoxy resins prior to melting. In certain embodiments, at least 98% of the micronized dicyandiamide has a particle size of 40 microns or less. In other embodiments, at least 98% of the micronized dicyandiamide has a particles size of 10 microns or less. In other embodiments, at least 98% of the micronized dicyandiamide has a particles size of 6 microns or less. Such materials are commercially available from AlzChem, under the tradename Dyhard®.

One or More Accelerators Different from the Latent Curing Agent

The liquid epoxy adhesive compositions comprise one or more accelerators. In certain embodiments, the one or more accelerators is or comprises urea, a guanidine, or a substituted urea Substituted urea accelerators are preferred. In other embodiments, the one or more accelerator is micronized, preferably a micronized substituted urea. In certain embodiments, the substituted urea is urea or a bridged diurea substituted with one, two, three, or four alkyl groups. In some embodiments, the urea-based accelerator is an optionally aryl-substituted 1,1-dialkyl-3-aryl urea. It is preferred, but not necessary, that the (substituted urea) accelerator becomes activated at a temperature that exceeds the deblocking temperature of the urethanes. In some embodiments, the accelerator becomes activated in a temperature range of 100° C. to 120° C., from 120° C. to 140° C., from 140° C. to 160° C., or from 160° C. to 180° C., or a combination of two or more of these ranges. Dyhard® UR series and Omicure® U series are commercially available from AlzChem and Huntsman, respectively. The former reportedly activated in a temperature range of from 120° C. to 140° C. and the literature characterizes UR700 as a substituted urea. Omicure® U-52M is commercially available from Huntsman reportedly having a structure of 4,4′ Methylene Bis-(Phenyl Dimethyl Urea) Both of these materials are useful in these liquid epoxy adhesive compositions, and the use of either (or both) in these compositions constitute individual embodiments of the present disclosure.

In some embodiments, liquid epoxy adhesive composition comprises at least two accelerators, each becoming activated at different temperatures. If two accelerators are present, it is preferred that the first of these is one that becomes activated (has an activation temperature) when heated to a temperature within the range of 60 to 120° C., and the second becomes when heated to a temperature of at least 140° C.

### Fillers

The liquid epoxy adhesive compositions contain solid fillers that are organic or inorganic materials and provide structural integrity to the compositions prior to curing. Such fillers are known to those skilled in the art. In certain embodiments, the one or more filler comprises one or more of calcium carbonate, calcium oxide, calcium silicate, aluminosilicate, organophilic phyllosilicates, naturally occurring clays such as bentonite, wollastonite or kaolin glass, silica, mica, talc, microspheres, or hollow glass microspheres (HGM), chopped or milled fibers (e.g., carbon, glass, or aramid), pigments, zeolites (natural or synthetic), or thermoplastic fillers. Calcium silicate and calcium oxide are preferred. Those fillers having low aspect ratios (e.g., less than about 1) and/or very high aspect ratios (e.g., chopped or milled fibers) are also preferred.

### Phenol Novolac Epoxies

Additionally or alternatively, in the adhesive composition, one or more phenol novolac epoxies are preferably included. These multifunctional epoxy resins are typically manufactured from phenol novolac resin and epichlorohydrin. When cured, they form cured materials that possess a mesh structure with a high cross-linking density. They also demonstrate excellent performance in heat and chemical resistance. In the liquid epoxy adhesive compositions described herein, the phenol novolac epoxies desirably have an EEW in a range of from 165 to 185, preferably from 172 to 179. Suitable epoxy novolac resins include those sold under the tradename D.E.N.®, including the 300 and 400 series epoxies, commercially available from Olin Corporation.

### Flame Retardants

The liquid epoxy adhesive composition may optionally contain one or more flame retardant. The one or more flame retardant may comprise a solid, a liquid or a combination thereof. In certain embodiments, the flame retardant is or comprises one or more of aluminum trihydrate (ATH) (which may also be categorized as a filler, though when present is categorized as a flame retardant for counting purposes), ammonium polyphosphates, melamine, melamine polyphosphate, a phosphonate ester (e.g., diethyl bis(hydroxyethyl) aminomethyl phosphonate (commercially available as Fyrol® 6 phosphonate ester), a halogen-free phosphorus ester (commercially available as Fyrol® HF-9), or any combination of a unsubstituted, mono-, di-, or tri-butylated phenyl phosphates (for example, Emerald Innovation NH1 is a low viscosity liquid flame retardant engineered for use in flexible polyurethane foams, said to comprise a mixture of di-butylated phenyl phosphate(s) and triphenyl phosphate and is commercially available).

In the present compositions, liquid fire retardants appear to be preferred, especially those having higher thermal stabilities. Additionally, or alternatively, mixtures comprising unsubstituted, mono-, di-, and/or tri-butylated phenyl phosphates are preferred.

Further, this disclosure includes examples of compositions consistent with these descriptions, with flammability resistance in the uncured state to resist ignition and flame propagation during welding through the uncured adhesive.

### Polyetheramine Flexibilizer

The liquid epoxy adhesive compositions may also optionally comprise one or more flexibilizers. The inclusion of these flexibilizers is believed to contribute to the improvements seen in compositions described herein, in particular adhesion to steel and aluminum and impact wedge peel strength after automotive E-coat ‘overbake’ or ‘high bake’ cure conditions and after uncured, open bead humidity exposure. In one embodiment, the one or more flexibilizers may comprise polyetheramine flexibilizers having a polyalkylene glycol backbone, further comprising amine end-caps, for example, diamines and triamines attached to a polyether backbone typically based on ethylene oxide (EO), propylene oxide (PO) or a mix of such compounds. In some embodiments, the one or more polyetheramine flexibilizer are present as a DGEBA adduct. The polyetheramine is preferably an end-capped polypropylene glycol characterized by repeating oxypropylene units in the backbone in sufficient number to provide an average weight averaged molecular weight in a range of from about 1000 to 3000 Daltons, more preferably about 2000 Daltons. Such materials are commercially available from Huntsman as JEFFAMINE® polyetheramines.

### Other Components

These liquid epoxy adhesive compositions may also optionally comprise additional components, for example additives such as adhesion promoters; plasticizers such as tricresyl phosphate and the like; diluents, e.g., epoxy compatible chemically inert hydrocarbon resin; extenders; colorant, e.g. pigments and dyes; thixotropic agents, e.g. surface treated fumed silica, mixed mineral thixotropes; coupling agents, e.g., silane coupling agents, such as a gamma-glycidoxypropyltrimethoxysilane coupling agent; expanding agents, flow control agents, and antioxidants. In certain embodiments, the liquid epoxy adhesive composition is free of formaldehyde.

Preferred adhesion promoters may be selected from materials increasing adhesion to metal substrates for example chelate-modified epoxy resin, a reaction product of epoxy resin and a compound containing a chelate functional group (chelate ligand). The chelate functional group is a functional group of a compound having multiple coordinations capable of chelating with metal ions in a molecule, and includes an acid group containing phosphorus (for example, —PO(OH)₂), a carboxyl group (—CO₂H), an acid group containing sulfur (for example, —SO₃H), an amino group and a hydroxyl group (particularly, hydroxyl groups neighboring each other in an aromatic ring) and the like. The chelate ligand may include ethylenediamine, bipyridine, ethylenediamine tetraacetic acid, phenanthroline, porphyrin, crown ether and the like. Examples of suitable commercially available chelate-modified epoxy resin include EP-49-10N available from Adeka Corporation and the like.

### Methods of Making the Liquid Epoxy Adhesive Compositions

Methods of making the liquid epoxy adhesive composition are set forth herein. In certain of these embodiments, the methods comprise combining the corresponding components at a temperature less than the activation energy of the final desired composition. In certain embodiments, this temperature is in a range of from about 20° C. to about 40° C., from about 40° C. to about 60° C., from about 60° C. to about 80° C., or any combination of two or more of the foregoing ranges.

It is generally most convenient to pre-mix those components that exist as liquids at ambient temperatures before adding those components that exists as solids at ambient temperature, but the order of mixing is not believed to be critical. One exemplary method is set forth in the Examples.

### Methods of Using the Liquid Epoxy Adhesive Compositions

One particularly preferred application for the adhesives according to the present invention is in methods of forming structural bonds in vehicle construction such as at metal-to-metal interfaces such as in hem flanges and in body panel joining, for example using weld bonding, a process that combines spot welding and adhesive bonding. The use of the liquid epoxy adhesive compositions in forming a bonding surface comprising a corresponding cured epoxy adhesive layer is considered independent embodiments of the present disclosure, as are the methods of using them for this purpose.

The liquid epoxy adhesive compositions can be applied to substrates by any convenient technique. Desirably the compositions are pumpable and can be applied cold or be applied warm if desired, preferably heating only up to a temperature at which the latent curing agent is not yet activated. It can be applied manually and/or robotically, using, for example, jet spraying methods or extrusion apparatus. The compositions can be applied by extrusion from a robot in bead form or by mechanical or manual application means and can also be applied using a swirl or streaming technique. The swirl and streaming techniques utilize equipment well known in the art such as pumps, control systems, dosing guns, remote dosing devices and application guns. The adhesive may be applied to one or both of the substrates to be joined. Once the liquid epoxy adhesive composition is applied, the substrates are contacted such that the adhesive is located at a bond line between the substrates. The substrates are contacted such that the adhesive is located between the substrates to be bonded together. Thereafter, the adhesive composition is subjected to heating to a temperature at which the heat curable or latent curing agent initiates cure of the epoxy resin composition forming a bonded assembly comprising the cured epoxy adhesive located between the substrates and adhered thereto.

In some embodiments, the adhesive is formulated to function as a hot melt; that is, an adhesive which is solid at room temperature, but capable of being converted to a pumpable or flowable material when heated to a temperature above room temperature. In another embodiment, the composition of this invention is formulated to be capable of being flowed or pumped to the work site at ambient temperatures or slightly above since, in most applications, it is preferable to ensure that the adhesive is heated only up to a temperature at which the latent curing agent is not yet activated. The melted composition may be applied directly to the substrate surface or may be allowed to flow into a space separately the substrates to be joined, such as in a hem flanging operation. In yet another embodiment, the composition is formulated (by inclusion of a finely divided thermoplastic or by use of multiple curatives having different activation temperatures, for example) such that the curing process proceeds in two or more stages (partial curing at a first temperature, complete curing at a second, higher temperature). The two parts are joined together, preferably immediately after deposition of the adhesive mass, thereby provisionally bonding the two parts to each other.

The resultant bond preferably already has sufficient strength so that the still uncured adhesive is not readily washed out, as might otherwise occur, for example, if the metal sheets which are provisionally bonded to each other are treated for de-greasing purposes in a wash bath and then in a phosphating bath.

The composition is preferably finally cured in an oven at a temperature which lies clearly above the temperature at which the composition was applied to the parts to be bonded and at or above the temperature at which the curing agent and/or accelerator and/or latent expanding agent (if present) are activated (i.e., in the case of the hardener, the minimum temperature at which the curing agent becomes reactive towards the other components of the adhesive; in the case of the expanding agent, the minimum temperature at which the expanding agent causes foaming or expansion of the adhesive). Curing is performed by heating the epoxy adhesive to a temperature of 140° C. or above. Preferably, the temperature is about 220° C. or less, and more preferably about 180° C. or less. The time needed to achieve full cure depends somewhat on temperature, but in general is at least 5 minutes, and more typically is 15 minutes to 120 minutes. Curing preferably takes place at a temperature above 150° C., for example at 160 to 220° C., for about 10 to about 120 minutes.

The epoxy adhesive can be used to bond a variety of substrates together including wood, metal, coated metal, aluminum, a variety of plastic and filled plastic substrates, fiberglass, and the like. The substrates to be joined using the adhesive may be the same as or different from each other. It is preferably used for the bonding of metal parts and particularly for the bonding of steel sheets such as cold rolled steel sheets. These can also be electro-galvanized, hot-dip galvanized and/or zinc/nickel-coated steel sheets, for example. The composition is especially useful for bonding substrates having surfaces contaminated with oily substances, as good adhesion is attained despite such contamination.

Once cured, the adhesive compositions according to the present invention may be used as casting resins in the electrical or electronics industry or as die attach adhesives in electronics for bonding components to printed circuit boards. Further possible applications for the compositions are as matrix materials for composites, such as fiber-reinforced composites. One particularly preferred application for the adhesives according to the present invention is the formation of structural bonds in vehicle construction such as in hem flanges and the like.

In preferred embodiments, the epoxy adhesive is used to bond parts of automobiles or other vehicles. Such parts can be steel, coated steel, galvanized steel, aluminum, coated aluminum, plastic and filled plastic substrates. An application of particular interest is in bonding vehicle frame components to each other or to other components of the vehicle. The frame components are often metals such as cold rolled steel, galvanized metals, or aluminum. The components to be bonded to the frame components can also be metals as just described, or can be other metals, plastics, composite materials, and the like. Assembled automotive frame members are usually coated with a coating material (e.g., paint) that requires a bake cure. The coating is typically baked at temperatures that may range from 140° C. to over 200° C., e.g., 177-204° C. for 10 to 20 minutes. In such cases, it is often convenient to apply the epoxy adhesive to the frame components, then apply the coating, and cure the epoxy adhesive at the same time the coating is baked and cured.

In some embodiments, curing is not performed immediately after the epoxy adhesive is applied. During such a delay before curing, the epoxy adhesive may be exposed to humid air at a temperature of up to about 40° C.

In some cases (the “open bead” case), the adhesive may be applied onto one of the substrates and left uncovered and exposed to ambient air for a period of time before the second substrate is brought into contact with the adhesive. In a manufacturing setting, the “open bead” case may occur, for example, when the adhesive is applied onto one of the substrates at or near the end of a working day or work week, but the next step of assembling the substrates together does not take place until work resumes on a subsequent work-day.

In other cases (the “closed bead” case), the second substrate is brought into contact with the adhesive, but the adhesive is left uncured and exposed to ambient air until a later time. This case occurs in manufacturing settings wherein the step of marrying the substrates is performed, but the resulting assembly is not cured until a later time. The uncured assembly may be, for example, stored and/or transported prior to curing. In such a case, the uncured adhesive may be exposed to humid air for a period of hours to months.

The adhesives of the invention are resistant to open bead and closed bead humid air exposure such that T-peel and other performance of the cured adhesive is maintained.

### Bonded Assemblies Comprising Cured Epoxy Adhesive Layers

The embodiments disclosed include the cured epoxy adhesive layers that have been prepared by thermally curing the liquid epoxy adhesive compositions set forth herein on a substrate preferably bonding two or more substrates together forming a bonded assembly. In preferred embodiments, the cured epoxy adhesive layer has a nominal thickness in a range of from 0.25 to 0.5 mm nominal, preferably about 0.25 mm.

These cured epoxy adhesive layers derive from curing the liquid epoxy adhesive compositions at temperatures in a range of from 140° C. to over 200° C., though in specific embodiments, the liquid compositions have been cured: (a) at a temperature of 160° C. for 10 minutes; or (b) at a temperature of 205° C. for 30 minutes.

Again, as set forth in the previous descriptions, the cured epoxy adhesive layers are adhered to substrates comprising a cold rolled steel (CRS), an electro galvanized steel (EZG), a hot dip galvanized steel (HDG), or a treated aluminum. The cured epoxy adhesive layer shows excellent adhesion to these substrates. In some embodiments, the cured epoxy adhesive layers exhibit a 100% cohesive mode of failure in peel on cold rolled steel (CRS), electro galvanized steel (EZG), hot dip galvanized steel (HDG), and/or treated aluminum when tested under T-peel conditions of ASTM D1876-08(2015)e1or under the wedge impact method of ISO 11343.2019. These results are attainable without resorting to high concentrations of filler to achieve 100% cohesive mode of failure.

The adhesive compositions described herein exhibit high T-peel strength after exposure to hot wet conditions in the uncured state. The compositions also provide good impact properties at −40° C. under low and high bake cure conditions. As exemplified in the Examples, the cured epoxy adhesive layers:
(a) having been cured between two 0.8 mm thick cold rolled steel plates at 160° C. for 10 min provides adhesion between the plates sufficient to exhibit a T-peel strength of at least 10, 11, 12, 13, 14, or 15 N/mm at room temperature; and/or
(b) having been cured between two 0.8 mm thick cold rolled steel plates at 205° C. for 30 min on provides adhesion between the plates sufficient to exhibit a T-peel strength of at least 10, 11, 12, 13, 14, or 15 N/mm at room temperature; and/or
(c) having been cured between two 0.8 mm thick cold rolled steel plates at 160° C. for 10 min exhibits a cleavage resistance under impact loading [impact wedge peel strength] of at least 20, 22, 24, 26, 28, 30, or 32 N/mm when tested using the wedge impact method of ISO 11343.2019 at −40° C.; and/or
(d) having been cured between two 0.8 mm thick cold rolled steel plates at 205° C. for 30 min exhibits a cleavage resistance under impact loading of at least 20, 22, 24, 26, 28, 30, or 32 N/mm when tested using the wedge impact method of ISO 11343.2019 at −40° C.; and/or
(e) having been cured between two 2.0 mm thick 5754 aluminum plates at 160° C. for 10 min provides adhesion between the plates sufficient to exhibit a T-peel strength of at least 10, 11, 12, 13, 14, or 15 N/mm at room temperature; and/or
(f) having been cured between two 2.0 mm thick 5754 aluminum plates at 205° C. for 30 min provides adhesion between the plates sufficient to exhibit a T-peel strength of at least 10, 11, 12, 13, 14, or 15 N/mm at room temperature.

The cured structural adhesive also exhibits good stress durability on aluminum in a hot/wet environment, for example, in some embodiments the ability to withstand a constant 7.68 MPa compressive shear load while reaching greater than 22 cycles of environmental aging according to Ford BV 101-07 “Stress Durability Test for Adhesive Lap-Shear Bonds” (described elsewhere herein) with no failed coupons after both low- and high-bake cure conditions. In other embodiments, the cured epoxy adhesive layer, having been cured for 10 minutes at 160° C., is able to withstand at least 25, 30, 35, 40, or 45 cycles of the environmental aging according to FLTM BV 101-07.

This disclosure embraces all articles of manufacturing comprising any of the liquid (pre-or partially cured) epoxy adhesive composition, as applied thereto (but not fully cured), as well as any cured epoxy adhesive layers adhered thereto. In certain embodiments, the article of manufacturing is an automobile, a home appliance, or a part thereof.

### Terms

In the present disclosure the singular forms “a,” “an,” and “the” include the plural reference, and reference to a particular numerical value includes at least that particular value, unless the context clearly indicates otherwise. Thus, for example, a reference to “a material” is a reference to at least one of such materials and/or equivalents thereof known to those skilled in the art, and so forth.

When a value is expressed as an approximation by use of the descriptor “about,” it will be understood that the particular value forms another embodiment. In general, the use of the term “about” indicates approximations that can vary depending on the desired properties sought to be obtained by the disclosed subject matter and is to be interpreted in the specific context in which it is used, based on its function. The person skilled in the art will be able to interpret this as a matter of routine. Where present, all ranges are inclusive and combinable. That is, references to values stated in ranges include every value within that range.

It is to be appreciated that certain features of the disclosure which are, for clarity, described herein in the context of separate embodiments, may also be provided in combination in a single embodiment. That is, unless obviously incompatible or specifically excluded, each individual embodiment is deemed to be combinable with any other embodiment(s) and such a combination is another embodiment. Conversely, various features of the disclosure that are, for brevity, described in the context of a single embodiment, may also be provided separately or in any sub-combination. Finally, while an embodiment may be described as part of a series of steps or part of a more general structure, each said step may also be considered an independent embodiment, combinable with others.

The transitional terms “comprising,” “consisting essentially of,” and “consisting” are intended to connote their generally accepted meanings in the patent lexicon; for those embodiments provided in terms of “consisting essentially of,” the basic and novel characteristic(s) is the facile operability of the methods or compositions/systems to provide compositions as exhibiting the claimed functional features using only those components listed.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C,” as separate embodiments.

Unless otherwise specified, compositional percentages are in terms of weight percent, relative to the weight of the material or composition.

The following examples are intended to complement, rather than displace or supersede, the previous descriptions.

### EXAMPLES

The following Examples provide experimental methods used to make and characterize the liquid epoxy adhesives and their transformations and performance. While each example disclosed in the specification is considered to provide specific individual embodiments of compositions, methods of preparation and use, none of the Examples is to be considered limiting of the more general embodiments described herein.

In the following examples, efforts have been made to ensure accuracy with respect to numbers used (e.g., amounts, temperature, etc.), but some experimental error and deviation should be accounted for. Unless indicated otherwise, temperature is in degrees C., and pressure is at or near atmospheric.

### Exemplary Mixing Conditions:

Diglycidyl ether of bisphenol (e.g. DGEBA and/or DGEBF) epoxy resin; epoxy novolac resin (poly[(phenyl glycidyl ether)-co-formaldehyde]; diluent; core shell rubber particles dispersed in DGEBA and/or DGEBF; a chelate modified glycidyl resin; carboxyl-terminated butadiene acrylonitrile (CTBN) adducted with DGEBA and/or DGEBF and dissolved in novolac epoxy resin; a polyurethane toughener; a gamma-glycidoxypropyltrimethoxysilane coupling agent; and plasticizer were combined in a 100 g max Thinky cup and mixed under vacuum on a Thinky mixer at 2,000 rpm for 1.5 min. After mixing the resinous components, solid filler and thixotropic agents were added to the mixture as follows: calcium oxide (CaO); pigment; surface functionalized, hydrophobic fumed silica thixotrope; and surface functionalized mixed mineral thixotrope; and mixed at atmospheric pressure followed by 8.0 kPa vacuum mixing, for 1.5 min. each at 2,000 rpm. Additional desired adjuvants and additives were blended into the mixture. Thereafter, a 1K curative package including dicyandiamide (DICY) and an accelerator were added to the batch and mixed at atmospheric pressure followed by 8.0 kPa vacuum mixing, for 1.5 min. each at 2,000 rpm. Care was taken to ensure the batch was not heated to greater than 55.0° C.

### Testing

Unless indicated otherwise, T-peel testing was performed under T-peel conditions of ASTM D1876-08(2015)e1. CRS coupon thickness was 0.8 mm and Ferrocote 6130 lube was applied and A1 coupon thickness was 2.0 mm and DC290 lube was applied. Metal coupons were cleaned with 2-propanol and wiped with a paper towel, before being coated with lube on one side. The adhesive composition was then applied to the lubed side of the coupon. Metal clips were used to hold the two coupons together during the cure cycle, typically baking at temperatures well in excess of ambient. Coupon/adhesive assemblies were cured as described below. Coupons for t-peel testing had 75 mm overlay and a width of 20 mm and were pulled using an Instrontester at a speed of 127 mm/min. The average load at plateau was used to calculate peel strength.

Coupons for impact peel testing having ISO 11343 test geometry (30 mm overlay, 20 mm width) were subjected to 90 J impact load at a drop weight speed of 2 m/s. Impact peel strength was measured at average impact load at plateau using an Instron Dynatup 9250 HV impact tester.

### Example 1. Effect of Polyurethane Toughener, Part 1

The influence of various toughening agents on resistance of uncured adhesives to open bead humidity exposure was examined. Test Compositions 1-6 were made according to the components listed in Table 1 below following the procedure of the Exemplary Mixing Conditions.

TABLE 1
Test Compositions 1-6

| | Comp | Comp | Comp | Comp | Comp | Comp |
|---|---|---|---|---|---|---|
| Components (g) | 1 | 2 | 3 | 4 | 5 | 6 |
| DGEBA resin | 40.90 | 40.90 | 40.90 | 40.90 | 40.90 | 16.90 |
| Dicyandiamide | 4.00 | 4.00 | 4.00 | 4.00 | 4.00 | 4.00 |
| urea accelerator | 0.00 | 0.83 | 0.00 | 0.00 | 0.00 | 0.00 |
| CaCO₃ | 2.00 | 2.00 | 2.00 | 2.00 | 2.00 | 2.00 |
| Hydrophobic treated fumed silica | 3.06 | 3.06 | 3.06 | 3.06 | 3.06 | 3.06 |
| Core shell rubber particles | 0.00 | 0.00 | 6.00 | 0.00 | 0.00 | 0.00 |
| PU1 | 0.00 | 0.00 | 0.00 | 6.00 | 0.00 | 0.00 |
| PU2 | 0.00 | 0.00 | 0.00 | 0.00 | 6.00 | 0.00 |
| CTBN-DGEBF in novolac epoxy resin | 0.00 | 0.00 | 0.00 | 0.00 | 0.00 | 30.00 |

The toughening agents PU1 and PU2 were both characterized as containing a polytetramethylene glycol (PTMEG) backbone. PU1 was described by the manufacturer as a bisphenol terminated polyurethane. PU2 was a polyurethane end-capped asymmetrically with an oxime and a hydrophobic mono-phenolic functional groups. PU2 exhibited a significantly lower deblock temperature than PU1 and had at least one endcap that was more hydrophobic than PU1 bisphenol end-caps.

Compositions 1-6 were utilized to determine the influence of individual toughening agents on uncured, open bead humidity resistance as follows: Each Composition was applied as an open bead of adhesive on a cold rolled steel (CRS) test coupon that had been prepared for T-peel testing, as described above. Individual test coupons with the open bead of adhesive were left uncovered and exposed to ambient air at 35° C., 85% Relative Humidity for a period of time indicated in Table 2 below. Then the second substrate was brought into contact with the adhesive, cured at 205° C. for 30 min. and T-peel strength was tested according to ASTM D1876-08(2015)e1. The test results are provided in Table 2 for initial T-peel strength of TO corresponding to no humidity aging, and various humidity exposure times of T24, T72 and T168 hours exposure followed by T-peel testing.

TABLE 2
Cured T-peel strength (N/mm) Initial and after
uncured, open bead humidity exposure.

| | T0 | After uncured | After uncured | After uncured |
|---|---|---|---|---|
| Composition | Initial | 24 hr. exposure | 72 hr. exposure | 168 hr. exposure |
| 1 | 1.1 | 1.2 | 1.2 | 1.2 |
| 2 | 0.9 | 0.9 | 1.0 | 0.8 |
| 3 | 1.8 | 3.6 | 4.6 | 3.9 |
| 4 | 4.0 | 5.5 | 5.2 | 4.8 |
| 5 | 5.3 | 7.2 | 7.8 | 7.5 |
| 6 | 4.6 | 5.6 | 5.4 | 5.2 |

These results show that compared to PU1, PU2 gave higher T-peel strengths initially and after uncured, open bead humidity exposure. Interestingly, each toughening agent investigated showed increased T-peel strengths after uncured, open bead humidity exposure.

### Example 1. Effect of Polyurethane Toughener, Part 2

PU2 was then compared directly to PU1 in a more complex structural adhesive composition, wherein the blocked polyurethane concentration was 9.58 wt. %. PU1 Example and PU2 Example were made according to the components listed in Table 3 below following the procedure of the Exemplary Mixing Conditions.

TABLE 3
Comparison of PU1 and PU2 blocked polyurethanes
in a structural adhesive composition.

| | PU1 Example | PU2 Example |
|---|---|---|
| Component (g) | | |
| DGEBA resin | 20.17 | 20.16 |
| Novolac epoxy resin | 9.07 | 9.07 |
| Diluent | 1.51 | 1.51 |
| Core shell rubber dispersion | 30.25 | 30.25 |
| CTBN-DGEBA adduct | 7.06 | 7.06 |
| PU1 | 9.58 | 0.00 |
| PU2 | 0.00 | 9.58 |
| CaO | 2.52 | 2.52 |
| Pigment | 0.03 | 0.03 |
| Calcium silicate | 11.60 | 11.60 |
| Hydrophobic fumed silica Thixotrope | 3.02 | 3.02 |
| Mixed Metal Thixotrope (MMT) | 0.50 | 0.50 |
| Aromatic substituted urea accelerator | 0.40 | 0.40 |
| Dicyandiamide | 4.29 | 4.29 |
| Total | 100 | 100 |
| Concentrations | | |
| DGEBA (wt. %) | 42.20 | 42.20 |
| Phenol novolac epoxy (wt. %) | 9.00 | 9.00 |
| CTBN (wt. %) | 2.80 | 2.80 |
| Core shell rubber particles (wt. %) | 12.00 | 12.00 |
| PU (wt. %) | 9.58 | 9.58 |
| DICY (wt. %) | 4.29 | 4.29 |

T-peel testing was performed, per ASTM D1876-08(2015)e1, using Table 3 compositions applied to CRS pre-lubed with Ferrocote 6130 oil and to A1 5754-A951-pre-lubed with DC290. Cold impact peel testing (ISO 11343) was also performed using these compositions applied to CRS, cured at high bake temperatures of 205° C. for 30 min. or “low bake” temperature of 160° C. for 10 min. and impact tested at −40° C. Results are shown in Table 4.

TABLE 4
Adhesion and impact peel results
of compositions shown in Table 3.

| Property | PU1 Example | PU2 Example |
|---|---|---|
| T-peel strength (N/mm), CRS (0.8 mm) | 5.6 | 9.4 |
| T-peel failure mode, CRS (0.8 mm) | Adhesive | Thin film |
| T-peel strength (N/mm), Al (2.0 mm) | 9.2 | 10.9 |
| T-peel failure mode, Al (2.0 mm) | Adhesive | Thin film |
| −40° C. impact peel (N/mm), CRS | 23.9 | 26.3 |
| (0.8 mm) | | |
| −40° C. impact peel (N/mm), 0.8 mm | 22.0 | 22.0 |
| CRS, 160° C., 10 min. cure | | |

Adhesive was cured prior to testing, at 205° C. for 30 min. unless another temperature/time is indicated.

These results show that PU2 gave a 67.9% improvement in T-peel strength on cold rolled steel (CRS) compared to PU1. Further, PU1 exhibited complete adhesive failure on both steel and aluminum substrates, while PU2 showed thin film failure, indicative of improved adhesion, as compared to PU1. It was also found that PU2 provided equivalent impact properties at −40° C., where typically some combination of blocked polyurethane, core-shell rubber and CTBN based toughening agents were utilized. In this case, both PU1 and PU2 showed good mode of failure after dynamic impact at −40° C. Like CTBN toughening chemistries, the PU phase separated during cure of the epoxy network under a reaction induced phase separation (RIPS) mechanism. Thermodynamically, phase separation of the PU is favorable as the free energy of mixing between the epoxy resin and the PU increases as the cure reaction progresses. Such a RIPS mechanism results in the formation of nano and/or micron scale, spherical, rubbery toughening adducts that activate cavitation, void growth and matrix shear yielding toughening mechanisms ahead of a growing crack. These toughening mechanisms occur under both static and dynamic fracture conditions.

### Example 2

Keeping PU2 as the polyurethane toughener, additional adhesive compositions Comparative Examples 1-3 and Example 2 were made according to Table 5, below, testing the effect of varying accelerators and the amount of PU2, on adhesion and impact properties before and after uncured, open bead humidity exposure.

TABLE 5
Adhesive compositions with varied PU2
concentration and accelerator type

| | Comp. | Comp. | Comp. | |
|---|---|---|---|---|
| | Ex. 1 | Ex. 2 | Ex. 3 | Ex. 2 |
| Component | | | | |
| DGEBA resin | 13.63 | 18.60 | 11.04 | 13.63 |
| Novolac epoxy resin | 7.60 | 0.00 | 7.60 | 7.60 |
| Diluent | 1.10 | 1.10 | 1.10 | 1.10 |
| Core shell rubber dispersion | 43.55 | 43.55 | 43.55 | 43.55 |
| Chelate modified epoxy resin | 1.10 | 1.10 | 1.10 | 1.10 |
| CTBN-DGEBF adduct in novolac | 8.89 | 8.89 | 8.89 | 8.89 |
| epoxy resin | | | | |
| Polyetheramine-DGEBA adduct | 0.00 | 0.00 | 0.00 | 0.00 |
| PU1 | 0.00 | 0.00 | 0.00 | 0.00 |
| PU2 | 7.57 | 10.2 | 9.66 | 7.57 |
| GLYMO coupling agent | 0.15 | 0.15 | 0.15 | 0.15 |
| Plasticizer | 2.01 | 2.01 | 2.01 | 2.01 |
| CaO | 6.00 | 6.00 | 6.00 | 6.00 |
| Pigment | 0.03 | 0.03 | 0.03 | 0.03 |
| Hydrophobic fumed silica | 3.06 | 3.06 | 3.06 | 3.06 |
| MMT | 0.48 | 0.48 | 0.48 | 0.48 |
| Aromatic substituted urea accelerator | 0.83 | 0.83 | 0.83 | 0.00 |
| Alkyl substituted urea accelerator | 0.00 | 0.00 | 0.00 | 0.83 |
| DICY | 4.00 | 4.00 | 4.00 | 4.00 |
| Concentrations | | | | |
| DGEBA (wt. %) | 40.75 | 45.72 | 38.16 | 40.75 |
| Phenol novolac epoxy (wt. %) | 14.71 | 7.11 | 14.71 | 14.71 |
| CTBN (wt. %) | 1.78 | 1.78 | 1.78 | 1.78 |
| Core shell rubber particles (wt. %) | 17.42 | 17.42 | 17.42 | 17.42 |
| PU (wt. %) | 7.57 | 10.20 | 9.66 | 7.57 |
| DICY (wt. %) | 4.00 | 4.00 | 4.50 | 4.00 |

Comparative Examples 1-3 and Example 2 were subjected to impact peel (N/mm) and T-peel (N/mm) testing according to Example 1, unless otherwise indicated below. Substrates of CRS were 0.8 mm thick and substrates of aluminum were 2.0 mm thick. These and additional testing and results are shown in Tables 6 and 7.

TABLE 6
Adhesion and impact properties of Comparative Examples 1-3 and Example 2.

| | Comp. | Comp. | Comp. | |
|---|---|---|---|---|
| Property | Ex. 1 | Ex. 2 | Ex. 3 | Ex. 2 |
| T-peel strength, CRS | 10.3 | 12.2 | 9.3 | 11.3 |
| Failure mode T-peel, CRS | Cohesive | Thin film | Thin film | Cohesive |
| T-peel strength, Al | 11.9 | 12.8 | 11.3 | 13.7 |
| Failure mode T-peel, Al | Cohesive | Cohesive | Cohesive | Cohesive |
| T-peel strength, Al after 72 hr. | 8.6 | 7.4 | 6.6 | 8.9 |
| uncured, open bead humidity exposure | | | | |
| T-peel failure surface foaming after | Minimal | Significant | Significant | Minimal |
| uncured, open bead humidity exposure | | | | |
| Lap shear strength (MPa), | 15.9 | 18.7 | 15.7 | 16.8 |
| ASTM D-1002, CRS | | | | |
| −40° C. impact peel, CRS | 0.00 | 28.9 | 27.9 | 26.4 |
| cured at 160° C. for 10 min. | | | | |
| Failure mode, CRS impact peel | Adhesive | ½ | ½ | Cohesive |
| | | Cohesive | Cohesive | |
| −40° C. impact peel, CRS | 21.4 | 33.0 | 27.3 | 20.0 |
| Failure mode, CRS impact peel | Cohesive | ½ | ½ | Cohesive |
| | | Cohesive | Cohesive | |
| −40° C. impact peel, Al | 0.00 | ND | ND | 21.4 |
| cured at 160° C. for 10 min. | | | | |
| Failure mode, Al | Adhesive | ND | ND | Cohesive |
| −40° C. impact peel, Al | 25.0 | ND | ND | 29.7 |
| Failure mode, Al | Cohesive | ND | ND | Cohesive |
| −40° C. impact peel, Al after 72 hr. | ND | ND | ND | 21.7 |
| uncured, open bead humidity exposure | | | | |

Surprisingly, as shown in Table 6, Example 2 provides high T-peel strengths on both steel and aluminum substrates and correspondingly 100% cohesive mode of failure. Good adhesion to both steel and aluminum substrates, along with good impact properties across a wide cure window is very difficult to achieve in a single formulation. Typically, different adhesive compositions are used to bond steel and aluminum substrates. For example, Betamate® 4601 is a high modulus epoxy adhesive used to bond A1 substrates (WO 2018/048655 A1). In further testing, according to ASTM D1876-08(2015)e1, Example 2 also showed cohesive mode of failure and good T-peel strengths on electro (EZG) and hot dipped (HDG) galvanized steels, respectively.

The data in Table 6 shows that the alkyl substituted urea accelerator provided a structural adhesive with higher T-peel strength on both steel and aluminum substrates, as compared to the aromatic substituted urea. This occurred despite the concentration of novolac epoxy resin or polyurethane toughening agents, which tended to provide a stiffer and lower modulus adhesive, respectively (see Comparative Examples 2 and 3).

These examples also show an adhesive composition that minimized ‘foaming’ due to the presence of moisture absorbed during uncured, open bead humidity exposure. Less foaming appeared related to the concentration of CaO and blocked polyurethane in the composition. Surprisingly, Example 2 provided an adhesive having a −40° C. impact peel strength value >20 N/mm after 72 hr. uncured, open bead humidity exposure. Typically, automotive OEMs in North America require an impact peel value >15 N/mm when the adhesive is tested without humidity exposure prior to cure and at −40° C. test temperature. Example 2 exhibited excellent humidity resistance in both static and dynamic peel conditions.

The adhesion and impact wedge peel data in Table 6 also show that Example 2 had improved adhesion to aluminum, which may be at least partially due to the combination of core shell rubber (CSR), carboxyl-terminated butadiene-acrylonitrile (CTBN) and polyurethane (PU) toughening agents, in addition to the use of the alkyl-substituted substituted urea accelerator.

Comparative Examples 1-3 and Example 2 were subjected to stress durability testing on aluminum test substrates as follows under Ford BV 101-07 “Stress Durability Test for Adhesive Lap-Shear Bonds”: six A1 5754-A951 lap shear coupons were cleaned with acetone and pairs of coupons were bonded together with a 12.7 mm bond overlap, 25.4 bond width and adhesive thickness of 0.25 mm were fastened with stainless steel bolts and glass fiber washers. Adhesive was cured at 205° C. for 30 min. prior to testing, unless otherwise indicated. Cure at 160° C. for 10 min. is considered a “low bake” condition. A string of bonded coupons was connected to a fixture, which was then placed under a load of 2400N. The loaded specimens and assembly were submerged in 5 wt. % NaCl solution having a pH of 7 according to the prescribed cycle. Each tube of specimens was cycled daily during workdays; otherwise, the tubes were left in the humidity condition described below (on weekends or holidays, for example). A single exposure cycle consists of 15±1 minutes in the 5 wt. % NaCl solution, followed by 105±5 minutes vertical drip drying at ambient lab conditions followed by 22 hours at 50±2° C. at 90±5% relative humidity. Typically, the test runs for at least 22 cycles. Results are shown in Table 7.

TABLE 7
Stress durability properties on Aluminum of
Comparative Examples 1-3 and Example 2.

| | Comp. | Comp. | Comp. | |
|---|---|---|---|---|
| Property | Ex. 1 | Ex. 2 | Ex. 3 | Ex. 2 |
| Cycles to 1^{st} coupon failure, cured | >45 | 42 | 43 | 45 |
| at 160° C. for 10 min. | | | | |
| Cycles to 2^{nd} coupon failure, cured | >45 | >45 | >45 | >45 |
| at 160° C. for 10 min. | | | | |
| Cycles to 3^{rd} coupon failure, cured | >45 | >45 | >45 | >45 |
| at 160° C. for 10 min. | | | | |
| Cycles to 1^{st} coupon failure | 6 | 10 | 20 | 25 |
| Cycles to 2^{nd} coupon failure | 36 | 20 | 44 | 38 |
| Cycles to 3^{rd} coupon failure | 45 | ND | ND | 41 |

Stress durability properties of Comparative Examples 1-3 and Example 2 on Aluminum show that adhesives cured under low bake conditions have comparable durability, but at high bake conditions of 205° C. for 30 min., Example 2 undergoes significantly more cycles before failure of 1^{st} coupon, compared to Comparative Example 1.

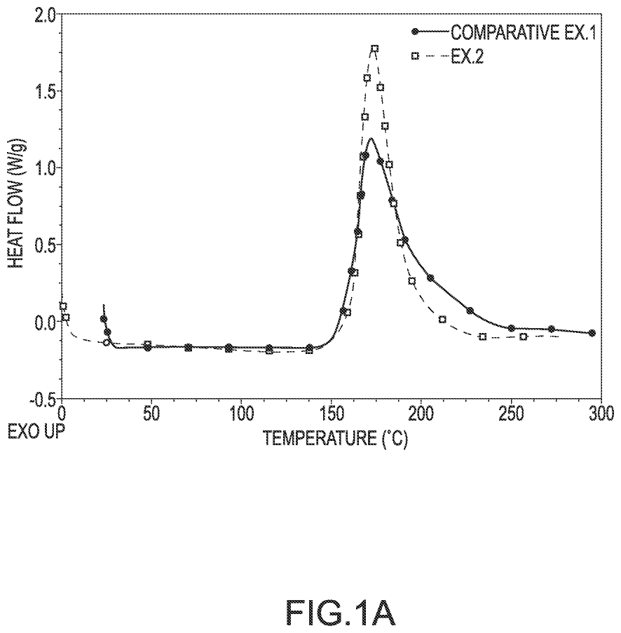

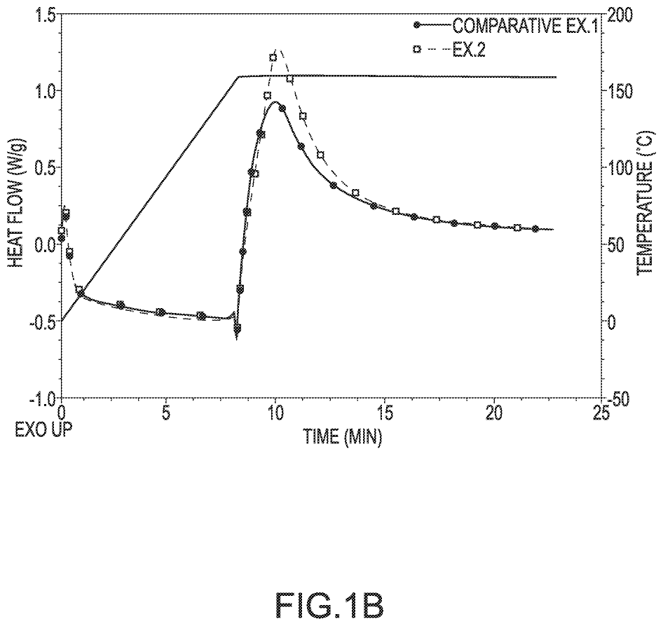

FIG. 1 shows differential scanning calorimetry (DSC) results for Comparative Example 1 and Example 2. FIG. 1A shows heat flow as a function of temperature. FIG. 1B shows a thermogram corresponding to the ‘low bake’ cure condition. Differential scanning calorimetry (DSC) results shown in FIG. 1A and FIG. 1B tend to show that the alkyl-substituted urea accelerator participated in the reaction more effectively did the aromatic substituted urea accelerator. Specifically, the thermograms in FIG. 1A indicates a sharper exotherm occurring under a lower range of temperatures vs the higher temperature activating accelerator. A thermogram corresponding to the ‘low bake’ cure condition in FIG. 1B shows that compared to the bulkier aromatic substituted urea accelerator, the alkyl-substituted substituted urea accelerator facilitated conversion of more available epoxy rings during the cure cycle, especially under low temperature cure conditions, which ensure the structural adhesive is adequately cured in OEM E-coat ovens, despite inherent temperature variation throughout the ovens and vehicle components. The alkyl substituted accelerator provided a greater extent of cure to both properly form the thermoset network for adhesion and to facilitate efficient reaction phase separation of the toughening agents during cure, leading to good impact wedge peel strength at −40° C. The dynamic mechanical analysis (DMA) results described in Table 8 support the DSC results.

Formulations corresponding to Comparative Examples 1, 2 and 3 from Table 5; as well as formulations corresponding to Example 2 from Table 5, Examples 3 and 4 from Table 9, and Example 5 from Table 12, were prepared and separate samples were cured under low bake (160° C. for 10 min.) or high bake (205° C. for 30 min.) conditions. The samples were subjected to dynamic mechanical analysis and the results are shown in Table 8 below.

TABLE 8
Dynamic mechanical analysis (DMA)
of Comp. Ex. 1-3, and Ex. 3-5.

| | Cure | T_{g} (° C.) via | E′ at 40° C. | E′ at 175° C. |
|---|---|---|---|---|
| Composition | Condition | max Tan δ | (MPa) | (MPa) |
| Comp. Ex. 1 | Low bake | 74.2 | 851.3 | 9.1 |
| | High bake | 136.8 | 1257.2 | 11.3 |
| Comp. Ex. 2 | Low bake | 86.9 | 741.9 | 8.3 |
| | High bake | 133.3 | 1248.9 | 9.7 |
| Comp. Ex. 3 | Low bake | 106.4 | 1084.1 | 9.6 |
| | High bake | 136.1 | 1298.1 | 10.3 |
| Example 2 | Low bake | 123.8 | 1444.2 | 11.0 |
| | High bake | 128.1 | 1254.1 | 7.8 |
| Example 3 | Low bake | 122.5 | 1472.4 | 11.3 |
| | High bake | 126.9 | 1322.8 | 7.3 |
| Example 4 | Low bake | 125.7 | 1512.8 | 13.7 |
| | High bake | 129.0 | 1478.5 | 9.5 |
| Example 5 | Low bake | 121.2 | 1332.3 | 11.7 |
| | High bake | 130.7 | 1148.3 | 8.9 |

Surprisingly, the DMA results in Table 8 show that after high bake cure conditions the alkyl-substituted substituted urea accelerator led to a cured composition having a lower modulus in the rubbery plateau. It was observed that compared to Comparative Example 1, Example 2 exhibited a greater number of stress durability cycles after overbake cure prior to failure, possibly because the adhesive could more efficiently distribute the load at the edges of the overlap where undercutting of the adhesive bond tended to occur.

### Examples 3 and 4

Additional crash and stress durable examples as shown in Table 9 were made and tested using testing regimens as described for Examples 1 and 2 unless indicated otherwise. Example 3 contains increased amounts of silicate filler and thixotrope, while Example 4 has an added component of polyetheramine-DGEBA adduct. Corresponding test data is shown in Tables 10 and 11.

TABLE 9
Crash and stress durable examples containing
polyetheramine-DGEBA adduct

| | Example 3 | Example 4 |
|---|---|---|
| Component | | |
| DGEBA resin | 22.48 | 20.32 |
| Novolac epoxy resin | 0.00 | 0.00 |
| Diluent | 0.00 | 0.00 |
| Core shell rubber dispersion | 38.00 | 33.92 |
| Chelate modified epoxy resin | 0.00 | 0.00 |
| CTBN-DGEBF adduct in novolac epoxy resin | 8.89 | 8.89 |
| Polyetheramine-DGEBA adduct | 0.00 | 10.71 |
| PU2 | 7.57 | 6.76 |
| GLYMO coupling agent | 0.15 | 0.13 |
| Plasticizer | 2.01 | 1.79 |
| CaO | 6.00 | 5.36 |
| Pigment | 0.03 | 0.03 |
| Calcium silicate | 6.00 | 5.36 |
| Hydrophobic fumed silica | 3.06 | 2.50 |
| MMT | 0.48 | 0.43 |
| HGM | 0.50 | 0.45 |
| Aromatic substituted urea | 0.00 | 0.00 |
| Alkyl substituted urea | 0.83 | 0.74 |
| DICY | 4.00 | 3.57 |
| Concentrations | | |
| DGEBA (wt. %) | 45.28 | 40.68 |
| Phenol novolac epoxy (wt. %) | 7.11 | 6.34 |
| CTBN (wt. %) | 1.78 | 1.59 |
| Core shell rubber particles (wt. %) | 15.20 | 13.57 |
| PU (wt. %) | 7.57 | 6.76 |
| PEA-DGEBA adduct | 0.00 | 10.71 |
| DICY (wt. %) | 4.00 | 3.57 |

Examples 3 and 4 were subjected to impact peel (N/mm) and T-peel (N/mm) testing according to Example 1, unless otherwise indicated below. Substrates of CRS had thicknesses as indicated in the Tables and substrates of aluminum were 2.0 mm thick.

TABLE 10
Adhesion and impact properties of compositions shown in Table 9.

| Property | Example 3 | Example 4 |
|---|---|---|
| T-peel strength, CRS (1.6 mm) | 16.2 | 17.9 |
| Failure mode T-peel, CRS (1.6 mm) | Cohesive | Cohesive |
| T-peel strength, Al | 10.9 | 13.8 |
| Failure mode T-peel, Al | Cohesive | Cohesive |
| T-peel strength, Al after 72 hr. | 7.3 | 9.4 |
| uncured, open bead humidity exposure | | |
| Extent of foaming on T-peel failure | Minimal | Minimal |
| surface after uncured, open bead humidity | | |
| exposure prior to adhesive cure | | |
| Lap shear strength (MPa), ASTM D1002, Al | | |
| Failure mode Lap shear, Al | 80% | 100% |
| | Cohesive | Cohesive |
| −40° C. impact peel, cured at 160° C. | 25.0 | 21.1 |
| for 10 min., CRS (0.8 mm) | | |
| Failure mode, CRS(0.8 mm) impact peel, | Cohesive | Cohesive |
| cured at 160° C. for 10 min. CRS | | |
| −40° C. impact peel, CRS (0.8 mm) | 22.5 | 25.9 |
| Failure mode, CRS impact peel CRS (0.8 mm) | 50% | 100% |
| | Cohesive | Cohesive |
| −40° C. impact peel (N/mm), cured at | 32.5 | 32.9 |
| 160° C. for 10 min., Al | | |
| Failure mode, Al | Cohesive | Cohesive |
| −40° C. impact peel, Al | 30.0 | 35.3 |
| Failure mode, Al | Cohesive | Cohesive |
| −40° C. impact peel, Al after 72 hr. | 15.8 | 22.9 |
| uncured, open bead humidity exposure | | |

Adhesive was cured at 205° C. for 30 min. prior to testing, unless otherwise indicated.

Examples 3 and 4 were subjected to stress durability testing on aluminum test substrates according to Ford BV 101-07 as described above for Example 2. Adhesives were cured at 205° C. for 30 min. prior to testing, unless otherwise indicated. Aluminum substrates used for testing were 5754-A951-DC290. The results of stress durability cycling are shown in Table 11.

TABLE 11
Stress durability properties of Examples 3 and 4.

| Property | Example 3 | Example 4 |
|---|---|---|
| Cycles to 1^{st} coupon failure, cured | >45 | >45 |
| at 160° C. for 10 min. | | |
| Cycles to 2^{nd} coupon failure, cured | >45 | >45 |
| at 160° C. for 10 min. | | |
| Cycles to 3^{rd} coupon failure, cured | >45 | >45 |
| at 160° C. for 10 min. | | |
| Cycles to 1^{st} coupon failure | 32 | 34 |
| Cycles to 2^{nd} coupon failure | 42 | 43 |
| Cycles to 3^{rd} coupon failure | 45 | 45 |

Test results in Table 11 show that incorporation of a calcium metasilicate in Example 3 improved stress durability properties compared to Example 2. This may have resulted from improved adhesion by increasing the shear modulus of the adhesive in the interphase (see Drzal, The Effect of Polymeric Matrix Mechanical Properties on the Fiber-Matrix Interfacial Shear Strength, Materials Science and Engineering: A, 126, 1990). An adhesion mechanism similar to that of epoxy adhesives bonded to inorganic surfaces, such as carbon fibers, may be operative here, wherein the needle shaped calcium metasilicate increased the shear modulus in the interphase some 5 to 5,000 Angstroms from the aluminum/epoxy interface. However, incorporation of filler can reduce impact wedge peel properties of structural adhesives, particularly at lower temperatures, e.g., −40° C.

As shown in test results for Example 4, incorporation of a polyetheramine-DGEBA adduct improved impact wedge peel strength and mode of failure on CRS and aluminum after overbake cure conditions, as compared to Example 3. Additionally, impact wedge peel strength after uncured, open bead humidity exposure was increased by 44.9% after incorporation of the polyetheramine-DGEBA adduct, even after a 10.7% reduction in CSR content. Thus, the good humidity resistance shown in Example 2 was maintained, along with a 36% increase in the stress durability ‘first cycle to failure’ after overbake cure.

### Examples 5-11

In some embodiments, the uncured adhesive composition may be applied to a workpiece and thereafter the workpiece may be spot welded to another metal substrate, with the spot weld point passing through the uncured adhesive, for example during assembly of the automotive body-in-white (BIW) structure prior to cure in the E-coat ovens. Therefore, the adhesive composition desirably includes a flame retardant to impart flammability resistance to the adhesive in the uncured state desirably without negatively affecting other performance properties of the adhesive.

Crash durable adhesive compositions of Examples 5-11 were made using the components listed in Table 12, below and tested to examine the influence of various flame retardant (FR) chemistries on uncured weld flammability resistance. In Table 12, FRs are solids: ATH; Melamine polyphosphate and Melamine; and liquids: Phos. 1, Phos. 2 and Phos. 3.

Glass beads (GB) were used to control bondline thickness; GBs may be mixed directly into the liquid adhesive or introduced during sample preparation as is known for applying to the uncured layer before bringing substrates to be bonded together.

TABLE 12
Compositions comprising various flame retardants

| | Ex. 5 | Ex. 6 | Ex. 7 | Ex. 8 | Ex. 9 | Ex. 10 | Ex. 11 |
|---|---|---|---|---|---|---|---|
| Component (g) | | | | | | | |
| DGEBA resin | 20.38 | 20.38 | 32.19 | 32.19 | 32.19 | 18.63 | 19.49 |
| Core shell rubber dispersion | 25.43 | 25.44 | 27.23 | 27.23 | 27.23 | 34.81 | 32.53 |
| CTBN-DGEBF adduct in | 6.85 | 6.86 | 7.34 | 7.34 | 7.34 | 8.14 | 7.61 |
| novolac epoxy resin | | | | | | | |
| Polyetheramine-DGEBA adduct | 0.00 | 0.00 | 0.00 | 0.00 | 0.00 | 9.81 | 10.27 |
| PU1 | 0.00 | 0.00 | 0.00 | 0.00 | 0.00 | 0.00 | 0.00 |
| PU2 | 5.84 | 5.84 | 6.25 | 6.25 | 6.25 | 6.19 | 6.48 |
| Plasticizer | 2.42 | 2.42 | 2.60 | 2.60 | 2.60 | 2.29 | 0.00 |
| CaO | 1.68 | 1.68 | 1.80 | 1.80 | 1.80 | 2.01 | 5.14 |
| Pigment | 0.02 | 0.02 | 0.02 | 0.02 | 0.02 | 0.03 | 0.03 |
| Calcium silicate | 0.00 | 0.00 | 0.00 | 0.00 | 0.00 | 0.00 | 5.14 |
| Hydrophobic fumed silica | 1.50 | 1.50 | 1.61 | 1.61 | 1.61 | 2.29 | 3.84 |
| HGM | 0.39 | 0.39 | 0.41 | 0.41 | 0.41 | 0.41 | 0.90 |
| GBs | 0.00 | 0.00 | 0.00 | 0.00 | 0.00 | 0.00 | 1.92 |
| ATH | 15.42 | 15.41 | 5.19 | 5.19 | 5.19 | 3.66 | 0.00 |
| Melamine polyphosphate | 15.42 | 0.00 | 0.00 | 0.00 | 0.00 | 0.00 | 0.00 |
| Melamine | 0.00 | 15.41 | 5.19 | 5.19 | 5.19 | 3.66 | 0.00 |
| Phos. 1 | 0.00 | 0.00 | 5.19 | 0.00 | 0.00 | 0.00 | 0.00 |
| Phos. 2 | 0.00 | 0.00 | 0.00 | 5.19 | 0.00 | 0.00 | 0.00 |
| Phos. 3 | 0.00 | 0.00 | 0.00 | 0.00 | 5.19 | 3.66 | 2.39 |
| Alkyl substituted urea | 0.78 | 0.78 | 0.83 | 0.83 | 0.83 | 0.76 | 0.84 |
| DICY | 3.88 | 3.88 | 4.15 | 4.15 | 4.15 | 3.66 | 3.42 |
| Concentrations | | | | | | | |
| DGEBA (wt. %) | 35.64 | 35.64 | 48.53 | 48.53 | 48.53 | 45.40 | 45.17 |
| Phenol novolac epoxy (wt. %) | 5.48 | 5.49 | 5.87 | 5.87 | 5.87 | 6.51 | 6.09 |
| CTBN (wt. %) | 1.37 | 1.37 | 1.47 | 1.47 | 1.47 | 1.63 | 1.52 |
| Core shell rubber particle (wt. %) | 10.17 | 10.18 | 10.89 | 10.89 | 10.89 | 13.92 | 13.01 |
| PU (wt. %) | 5.84 | 5.84 | 6.25 | 6.25 | 6.25 | 6.19 | 6.48 |
| FR (wt. %) | 30.84 | 30.82 | 15.57 | 15.57 | 15.57 | 10.98 | 2.39 |
| DICY (wt. %) | 3.88 | 3.88 | 4.15 | 4.15 | 4.15 | 3.66 | 3.42 |

Phos. 1 is diethyl bis(hydroxyethyl) aminomethyl phosphonate (12% P);
Phos. 2 is Phosphorus ester (10.8% P);
Phos. 3 is phenyl isobutylated phosphate, triphenyl phosphate (7.9% P).

The compositions of Ex. 5-11 were subjected to performance testing of weld flammability as follows: a layer of uncured adhesive was formed between two cleaned metal panels, and a series of 34 welds were made at specific spatial intervals, performed by medium frequency DC. This test was repeated for a total of 170 welds on 5 specimens. The panels were observed during welding to see if the adhesive ignited. A “pass” rating is (a) when the structural adhesive ignites only in 4 or less welds out of 170 times, and (b) when any combustion that occurs self-extinguishes within 30 seconds, per (a) FLTM BV 114-01 for steel substrates, and/or (b) FLTM BV 062-01 for aluminum substrates. Results are shown in Table 13.

Impact, adhesion and stress durability were also measured for adhesives that passed the weld flammability tests. As shown in Table 13, Applicants developed flame retardant liquid adhesive compositions that pass uncured flammability and weldability testing providing improved flame resistance suitable for welding and retaining impact, adhesion, and stress durability performance.

TABLE 13
Performance test results of Example 5-11

| Property | Ex. 5 | Ex. 6 | Ex. 7 | Ex. 8 | Ex. 9 | Ex. 10 | Ex. 11 |
|---|---|---|---|---|---|---|---|
| Weld flammability test | Fail | Pass | Fail | Fail | Pass | Pass | Pass |
| −40° C. impact peel (N/mm), | ND | 0.00 | ND | ND | ND | 0.00 | 28.6 |
| Failure mode, CRS | ND | Adhesive | ND | ND | ND | ND | Cohesive |
| −40° C. impact peel (N/mm), | ND | ND | ND | ND | ND | ND | 34.5 |
| Al (2.0 mm) | | | | | | | |
| Failure mode, Al | ND | ND | ND | ND | ND | ND | Cohesive |
| T-peel strength (N/mm), Al | 5.0 | 5.0 | ND | ND | ND | ND | 11.8 |
| (2.0 mm) | | | | | | | |
| Failure mode, Al (2.0 mm) | Adhesive | Adhesive | ND | ND | ND | ND | Cohesive |
| T-peel strength (N/mm), | ND | ND | ND | ND | ND | ND | 12.4 |
| CRS (0.8 mm) | | | | | | | |
| Failure mode, CRS (0.8 mm) | ND | ND | ND | ND | ND | ND | Cohesive |
| Stress durability cycles to 1^{st} | ND | ND | ND | ND | ND | ND | 41 |
| coupon failure, cured at | | | | | | | |
| 160° C. for 10 min. | | | | | | | |
| Stress durability cycles to 1^{st} | ND | ND | ND | ND | ND | ND | 30 |
| coupon failure | | | | | | | |

“ND”: not determined.

The results in Table 12 and 13 show that solid FRs melamine and ATH can be incorporated into the structural adhesive but required high concentrations of these solid particulate FRs to pass the weld flammability test. However, the high concentration of solid FR materials tended to embrittle the cured adhesive composition resulting in poor impact wedge peel strength at −40° C., poor fracture toughness and subsequent poor adhesion, especially at −40° C.

It was discovered that particular combinations of liquid phosphate-containing flame retardants, e.g., mono-, di-, and tri-butylated phenyl phosphate(s) and triphenyl phosphate, and low concentrations of solid flame retardants such as ammonium polyphosphate, melamine and ATH suppressed flame up and propagation during weld flammability testing (see Example 9). More surprisingly, Applicants found that incorporating a blend of phenyl isobutylated phosphate and triphenyl phosphate having 7.9% phosphorus in non-zero amounts up to less than 3 wt. % in the composition (see Example 11) effectively mitigated ‘flame ups’ and quickly extinguished a flame during weld flammability testing.

Accordingly, the compositions of the invention may be made with minimal or in the absence of solid flame retardant. This is advantageous, since solid flame retardants were found to decrease adhesive fracture toughness, T-peel strength, and impact strength. Also, lower solid filler content leads to increased elongation; for example, Example 11 had an elongation of 12.3±1.8% (ASTM D638). Finally, the lower viscosity of adhesive without high concentrations of solid flame retardant fillers facilitated passing aluminum acceptance welding testing.

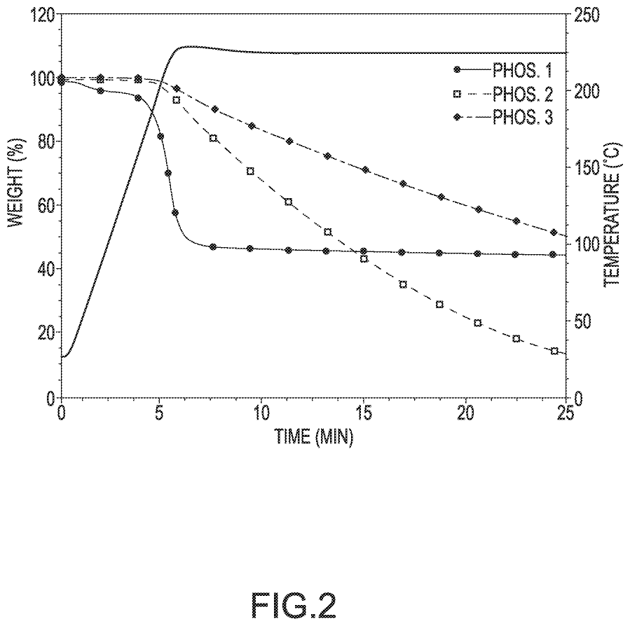

Thermogravimetric analysis (TGA) was used to study the mechanism of the phosphorus-containing flame retardants investigated in this work. FIG. 2 shows isothermal thermogravimetric analysis (TGA) curves of phosphorus flame retardants Phos. 1, Phos. 2 and Phos. 3, used in the formulations of Table 12 & 13. The TGA curves show that Phos. 3 used in Example 11 exhibited higher thermal stability as compared to Phos. 1 and 2, which had higher concentrations of phosphorus but failed weld flammability testing. Thus, phosphorus concentration alone did not govern the weld flammability resistance. Thermal stability of the flame retardant played a role in suppression and extinguishing of flame-ups throughout the entire weld flammability test.

### Examples 12-17 and Comparative Example 4

Examples 12-17 and Comparative Example 4 were made according to Table 14, below, using modified formulations that omit rubber tougheners thereby decoupling rubber effects from that of various polyurethane tougheners and amounts thereof. The compositions were tested for T-peel (N/mm) strength on HDG and Aluminum substrates according to ASTM D1876-08(2015)e1 and the test results are also shown in Table 14. PU1 improved T-peel on Aluminum, but resulted in adhesive failure on HDG. PU2 provided satisfactory improvements to T-peel strength on both Aluminum and HDG with cohesive failure mode on both subtrates.

TABLE 14
Examples 12-17 and Comparative Example 4 Compositions and T-Peel Test Results

| | Comp. | | | | | | |
|---|---|---|---|---|---|---|---|
| | Ex. 4 | Ex. 12 | Ex. 13 | Ex. 14 | Ex. 15 | Ex. 16 | Ex. 17 |
| Components | | | | | | | |
| (wt. %) | | | | | | | |
| DGEBA resin | 72.78 | 69.14 | 65.50 | 55.90 | 69.14 | 65.50 | 55.90 |
| PU1 | 0.00 | 5.00 | 10.00 | 20.00 | 0.00 | 0.00 | 0.00 |
| PU2 | 0.00 | 0.00 | 0.00 | 0.00 | 5.00 | 10.00 | 20.00 |
| CaO | 5.68 | 5.40 | 5.12 | 5.18 | 5.40 | 5.12 | 5.18 |
| Pigment | 0.03 | 0.03 | 0.03 | 0.03 | 0.03 | 0.03 | 0.03 |
| Calcium silicate | 5.68 | 5.40 | 5.12 | 5.18 | 5.40 | 5.12 | 5.18 |
| GBs | 2.12 | 2.01 | 1.91 | 1.93 | 2.01 | 1.91 | 1.93 |
| Phos. 3 | 2.65 | 2.52 | 2.38 | 2.41 | 2.52 | 2.38 | 2.41 |
| Hydrophobic | 4.24 | 4.03 | 3.82 | 3.86 | 4.03 | 3.82 | 3.86 |
| fumed silica | | | | | | | |
| HGM | 0.99 | 0.94 | 0.89 | 0.90 | 0.94 | 0.89 | 0.90 |
| Alkyl substituted | 0.92 | 0.88 | 0.83 | 0.84 | 0.88 | 0.83 | 0.84 |
| urea | | | | | | | |
| DICY | 4.90 | 4.66 | 4.41 | 3.77 | 4.66 | 4.41 | 3.77 |
| Total | 100.00% | 100.00% | 100.00% | 100.00% | 100.00% | 100.00% | 100.00% |

Concentrations

| | | | | | | | |
|---|---|---|---|---|---|---|---|
| DGEBA (wt. %) | 72.78 | 69.14 | 65.50 | 55.90 | 69.14 | 65.50 | 55.90 |
| Phenol novolac | 0 | 0 | 0 | 0 | 0 | 0 | 0 |
| epoxy (wt. %) | | | | | | | |
| CTBN (wt. %) | 0 | 0 | 0 | 0 | 0 | 0 | 0 |
| Core shell rubber | 0 | 0 | 0 | 0 | 0 | 0 | 0 |
| particles (wt. %) | | | | | | | |
| PU (wt. %) | 0 | 5.00 | 10.00 | 20.00 | 5.00 | 10.00 | 20.00 |
| FR (wt. %) | 2.65 | 2.52 | 2.38 | 2.41 | 2.52 | 2.38 | 2.41 |
| DICY (wt. %) | 4.90 | 4.66 | 4.41 | 3.77 | 4.66 | 4.41 | 3.77 |
| Property Tested | | | | | | | |
| HDG 0.8 mm T- | 4.6 | 6.1 | 4.6 | 5.6 | 7.4 | 12.3 | 11.5 |
| Peel Strength | | | | | | | |
| HDG T-Peel | Mixed | Thin | Adhesive | Adhesive | Thin | Cohesive | Cohesive |
| Strength Failure | Mode | Film | | | Film | | |
| Mode | | | | | | | |
| Aluminum 3.0 mm | 5.1 | 7.9 | 11.1 | 14.2 | 8.1 | 13.2 | 12.6 |
| T-Peel Strength | | | | | | | |
| Al T-Peel Strength | Cohesive | Cohesive | Cohesive | Cohesive | Cohesive | Cohesive | Cohesive |
| Failure Mode | | | | | | | |

As those skilled in the art will appreciate, numerous modifications and variations of the present invention are possible in light of these teachings, and all such are contemplated hereby. All references cited herein are incorporated by reference herein, at least for their teachings in the context presented.

What is claimed:

1. A liquid epoxy adhesive composition comprising:
(a) at least one epoxy resin;
(b) one or more carboxyl-terminated butadiene homopolymers or butadiene acrylonitrile copolymers (CTBN);
(c) rubber particles, optionally including core-shell rubber particles and/or particles of size 500 nm or less;
(d) one or more blocked polyurethane toughening agents;
(e) at least one heat-activated latent curing agent comprising DICY;
(f) at least one accelerator different from the curing agent;
wherein the one or more blocked polyurethane toughening agents comprises at least one asymmetrically end-capped polyurethane.

2. The liquid epoxy adhesive composition of claim 1 wherein the components (a)-(f) comprise:
(a) one or more diglycidyl ether of a bisphenol-A (DGEBA) epoxy resins or bisphenol-F (DGEBF) epoxy resins, optionally having a quantity range of from 20 wt. % to 60 wt. %;
(b) one or more carboxyl-terminated butadiene acrylonitrile copolymers (CTBN), optionally having a quantity range of from 1 wt. % to 8 wt. %;
(c) core shell rubber (CSR) particles, optionally having a quantity range of from 5 wt. % to 30 wt. %;
(d) one or more blocked polyurethane toughening agents, optionally having a quantity range of from 5 wt. % to 20 wt. %;
(e) one or more dicyandiamides (DICY), optionally having a quantity range of from 2 wt. % to 6 wt. %;
(f) one or more urea-based accelerator, optionally having a quantity range of from 0.5 wt. % to 2.0 wt. %; and
optionally further comprising:
(g) one or more filler, optionally having a quantity range of from 0 wt. % to 20 wt. %;
(h) one or more phenol novolac epoxies, optionally having a quantity range of from 0 wt. % to 20 wt. %;
(i) one or more flame retardants, optionally having a quantity range of from 0 wt. % to 35 wt. %;
(j) one or more polyetheramine flexibilizer, optionally having a quantity range of from 0 wt. % to 12 wt. %; and
(k) one or more plasticizers, optionally having a quantity range of from 0 wt. % to 5 wt. %;
wherein the wt. % of each component is relative to the total weight of the composition and the total amount of the components does not exceed 100 wt. %.

3. The liquid epoxy adhesive composition of claim 2, wherein the one or more of diglycidyl ether of the bisphenol-A (DGEBA) epoxy resin or the bisphenol-F (DGEBF) epoxy resins has an Epoxy Equivalent Weight (EEW) in a range of from 180 to 195 where
$$EEW = \frac{MW epoxy resin}{\# of epoxy groups} .$$

4. The liquid epoxy adhesive composition of claim 1, wherein the one or more carboxyl-terminated butadiene acrylonitrile (CTBN) comprises a copolymer of butadiene and a nitrile monomer, optionally including acrylonitrile.

5. The liquid epoxy adhesive composition of claim 1, wherein the one or more carboxyl-terminated butadiene acrylonitrile (CTBN) is adducted with DGEBF.

6. The liquid epoxy adhesive composition of claim 1, wherein the core shell rubber (CSR) particles:
(a) are monomodally or bimodally dispersed;
(b) have a mean particle size of 50 nm, 75 nm, 100 nm, 125 nm, 150 nm, 175 nm, 200 nm, 250 nm, or 500 nm, or in a range bounded by any two of the foregoing values;
(c) have a core comprising, consisting essentially of, or consisting of polybutadiene, a butadiene/styrene copolymer, or an acrylic polymer or copolymer; and/or
(d) are dispersed in DGEBA epoxy resin.

7. The liquid epoxy adhesive composition of claim 1, wherein the one or more blocked polyurethane toughening agent comprises a polyalkylene glycol segment, optionally including polytetramethylene glycol (poly-THF or PTMEG), and has an equivalent molecular weight in a range of from 2000-5000 Daltons, wherein the polyalkylene glycol segment optionally is flanked at both ends by polyalkylene (extender) segments, optionally including C₁₋₁₀ alkylene linkages, and the polyurethane toughening agent is end capped at both ends.

8. The liquid epoxy adhesive composition of claim 7, wherein each end cap is independently a substituted phenol or bisphenol (or a hydroxyheteroaryl analog), an amine, methacryl, acetoxy, oxime, and/or pyrazole.

9. The liquid epoxy adhesive composition of claim 1, wherein the one or more dicyandiamide (DICY) comprises a micronized dicyandiamide, wherein d90 of the micronized dicyandiamide has a particle diameter of 40 microns or less; and the accelerator is or comprises urea, a guanidine, or a substituted urea.

10. The liquid epoxy adhesive composition of claim 2, wherein the one or more flame retardant is present and comprises one or more of aluminum trihydrate (ATH), an ammonium polyphosphate, melamine, melamine polyphosphate, a phosphonate ester, a halogen-free phosphorus ester, or any combination of unsubstituted, mono-, di-, or tri-butylated phenyl phosphates.

11. The liquid epoxy adhesive composition of claim 2, wherein the one or more filler comprises one or more of calcium carbonate, calcium oxide, calcium silicate, aluminosilicate, organophilic phyllosilicates, naturally occurring clays, silica, mica, talc, microspheres, or hollow glass microspheres, chopped or milled fibers optionally comprising carbon, glass, or aramid fibers, pigments, natural and/or synthetic zeolites, or thermoplastic fillers.

12. The liquid epoxy adhesive composition of claim 1, wherein the at least one accelerator different from the curing agent is or comprises a micronized urea-based accelerator, wherein the urea-based accelerator is urea, substituted urea having one, two, three, or four alkyl groups or a methylene bridged bis(phenylurea)N-substituted with one, two, three, or four alkyl groups, and/or wherein the accelerator becomes activated in a temperature range of 100° C. to 180° C.

13. The liquid epoxy adhesive composition of claim 2, wherein the one or more polyetheramine flexibilizer is or comprises an amine end-capped polyalkylene glycol, having an average weight averaged molecular weight in a range of from about 1000 to 3000 Daltons, the one or more polyetheramine flexibilizer optionally including a DGEBA adduct.

14. A method of preparing the liquid epoxy adhesive composition of claim 1, the method comprising steps, at a temperature less than the activation energy of the final desired composition, of: 1) combining liquid components, 2) mixing solid components, except curing agent and accelerator, into the combination of step 1), and 3) incorporating the curing agent and the accelerator into the mixture.

15. A method of making a bonded assembly comprising steps of: applying the liquid epoxy adhesive composition of claim 1 on a first surface, contacting at least one second surface with the composition on the first surface and curing the composition in contact with the first and second surfaces to prepare a bonded assembly.

16. The method of claim 15 wherein one or more of the first and second surfaces is contaminated with at least one oily substance and the liquid epoxy adhesive composition additionally comprises at least one chelate-modified epoxy resin.

17. The method of claim 15 wherein the curing step comprises thermally curing the liquid epoxy adhesive composition at a temperature in a range of from 140° C. to 220° C.

18. A bonded assembly made according to the method of claim 17, which when cured exhibits a 100% cohesive mode of failure in peel on cold rolled steel (CRS), electro galvanized steel (EZG), hot dip galvanized steel (HDG), and/or treated aluminum when tested under T-peel conditions of ASTM D1876-08(2015)e1 or under the wedge impact method of ISO 11343.2019.

19. An article of manufacturing comprising the liquid epoxy adhesive composition of claim 1, as applied on at least one surface of the article and uncured; or cured on the at least one surface of the article, wherein the article of manufacturing is optionally an automobile or a part thereof.
